(19) United States
(12) Patent Application Publication
(10) Pub. No.: US 2015/0277206 A1
(43) Pub. Date: Oct. 1, 2015

(54) METHOD FOR PREPARING ELECTROPHORETIC PARTICLE, ELECTROPHORETIC PARTICLE, ELECTROPHORETIC DISPERSION, ELECTROPHORETIC SHEET, ELECTROPHORETIC APPARATUS, AND ELECTRONIC APPLIANCE

(71) Applicant: Seiko Epson Corporation, Tokyo (JP)

(72) Inventors: Takashi Aoki, Higashiura-shi (JP); Shinobu Yokokawa, Okaya-shi (JP)

(21) Appl. No.: 14/662,316

(22) Filed: Mar. 19, 2015

(30) Foreign Application Priority Data
Mar. 27, 2014 (JP) 2014-066355
Mar. 27, 2014 (JP) 2014-066356
Mar. 27, 2014 (JP) 2014-066357

(51) Int. Cl. G02F 1/167; G02F 1/00

(52) U.S. Cl. CPC G02F 1/167; G02F 1/0009; G02F 2001/1678

(57) ABSTRACT

Provided is a method for preparing an electrophoretic particle including a particle and a coating layer covering at least a part of the particle, including obtaining the plurality of block copolymers having dispersion portions and crosslinking/adsorbing portions having crosslinking groups and being linked to the dispersion portions; adsorbing the crosslinking/adsorbing portion onto the surface of the particle; and crosslinking the crosslinking groups by a crosslinking agent to link the plurality of block copolymers, thereby forming the coating layer. The dispersion portions are formed by the living polymerization of first monomers having functional groups contributing the dispersibility of the particles into a dispersion medium, and the crosslinking/adsorbing portions are formed by the living polymerization of at least one kind of monomers, and thus provided with adsorbability onto the surface of the particles.

### BACKGROUND

1. Technical Field

The present invention relates to a method for preparing an electrophoretic particle, an electrophoretic particle, an electrophoretic dispersion, an electrophoretic sheet, an electrophoretic apparatus, and an electronic device.

2. Related Art

It has been generally known that fine particles move (migrate) in liquid by coulomb force when an electric field is applied to a dispersion system in which the fine particles are dispersed in the liquid, and this phenomenon is called electrophoresis. An electrophoretic display apparatus which utilizes the electrophoresis to display desired information (image) has recently attracted attention as a new display apparatus.

The electrophoretic display device has features in that it has a display memory property where a voltage is not applied and a wide viewing angle, and is capable of providing a high-contrast display at low power consumption, and so on.

In addition, the electrophoretic display device is a non-light-emitting device, and accordingly, has another feature in that it has a lower impact on viewer's eyes, as compared to light-emitting display devices including a cathode-ray tube display.

As such an electrophoretic display device, a device which is provided with dispersion of electrophoretic particles in a solvent as electrophoretic dispersion which is arranged between a pair of substrates with electrodes has been known.

Such an electrophoretic dispersion having the above configuration includes positively chargeable electrophoretic particles and negatively chargeable electrophoretic particles as the electrophoretic particles. By applying voltage between the pair of substrates (electrodes), the positively chargeable electrophoretic particles move to one side of a substrate and the negatively chargeable electrophoretic particles move to the other side of the substrate, and thus, desired information (image) can thus be displayed.

Here, the electrophoretic particles 501 which are provided with coating layers 503 including base particles 502 and polymers 533 linked to the base particles 502 are used (see FIG. 11). With such a configuration including the coating layers 503 (polymers 533), it is possible to disperse and charge the electrophoretic particles 501 in the electrophoretic dispersion.

In addition, the electrophoretic particles with such a configuration are prepared in the following manner by using an atom transfer radical polymerization (ATRP) reaction, for example.

That is, the electrophoretic particles 501 are prepared by first preparing the base particles 502, and coupling a silane coupling agent 531 having a polymerization initiation group with the surface of the base particles 502, then forming a polymerization part 532 at which monomers have been polymerized in living radical polymerization from the polymerization initiation group as a starting point, and providing a polymer 533 including the polymerization part 532 on the surface of the base particles 502 provided with properties such as electric chargeability and dispersibility (see, for example, JP-A-2013-156381).

However, in the electrophoretic particles 501 prepared by using such ATRP, the polymers 533 are linked to the surface of the base particles 502 by first linking a silane coupling agent to the surface of the base particles 502 as described above, and then polymerizing the monomers using the polymerization initiating group included in the silane coupling agent as a starting point.

Therefore, it is necessary for the base particles 502 to expose a functional group capable of being linked with the silane coupling agent on the surface of the base particles 502.

However, depending on the kind of the base particles, the base particles do not have such a functional group on the surface thereof. For the base particles not having such a functional group on the surface thereof, a polymer cannot be fixed on the surface of the particles according to a chemically stable method such as covalent bonding. In this case, there has been a problem in that the polymers are released from the surface of the base particles, and thus, long-term stability could not be secured.

### SUMMARY

An advantage of some aspects of the invention is to provide a method for preparing an electrophoretic particle, in which a polymer can be stably fixed on the surface of a base particle, even though the base particles are those having no functional group on the surface thereof, irrespective of the kind of the base particles; an electrophoretic particle having such the polymer fixed on the surface of the particle; and an electrophoretic dispersion, an electrophoretic sheet, an electrophoretic apparatus, and an electronic device, each having high reliability by using such the electrophoretic particle.

Such an advantage is achieved by the invention as follows.

The method for preparing an electrophoretic particle of the invention is a method for preparing an electrophoretic particle including a particle and a coating layer covering at least a part of the particle, including: obtaining a plurality of block copolymers having dispersion portions and crosslinking/adsorbing portions having crosslinking groups and being linked to the dispersion portions; adsorbing the crosslinking/adsorbing portions included in the plurality of block copolymers onto the surface of the particles; and crosslinking the crosslinking groups by a crosslinking agent to link the plurality of block copolymers, thereby forming the coating layer, wherein the dispersion portions are formed by the living polymerization of first monomers having functional groups contributing to the dispersibility of the particles into a dispersion medium, and the crosslinking/adsorbing portions are formed by the living polymerization of at least one kind of monomer, and thus provided with adsorbability onto the surface of the particles.

Thus, even though the base particles are those having no functional group on the surface thereof, irrespective of the kind of the base particles (particles), the block copolymers can be fixed on the surface of the particles.

In the method for preparing an electrophoretic particle of the invention, it is preferable that the at least one kind of monomers includes second monomers having the crosslinking groups and third monomers having the particle adsorbing groups provided with adsorbability, and in the process of obtaining the plurality of block copolymers, the crosslinking/adsorbing portions are formed by the copolymerization of the second monomers and the third monomers.

Thus, even though the base particles are those having no functional group on the surface thereof, irrespective of the kind of the base particles, the block copolymers can be fixed on the surface of the particles.

In the method for preparing an electrophoretic particle of the invention, it is preferable that the process of obtaining a plurality of block copolymers includes forming a crosslinking portion by the polymerization of the second monomers and forming an adsorbing portion by the polymerization of the third monomers, and the crosslinking/adsorbing portions are formed by obtaining block copolymers having the crosslinking portions and the adsorbing portions linked to each other.

Thus, even though the base particles are those having no functional group on the surface thereof, irrespective of the kind of the base particles, the block copolymers can be more assuredly fixed on the surface of the particles.

In the method for preparing an electrophoretic particle of the invention, it is preferable that in the process of obtaining the plurality of block copolymers, the crosslinking/adsorbing portions are formed by obtaining random copolymers by the copolymerization of the second monomers and the third monomers in the presence of both of the second monomers and the third monomers.

Thus, even though the base particles are those having no functional group on the surface thereof, irrespective of the kind of the base particles, the block copolymers can be fixed on the surface of the particles. Further, simplification of the processes can be promoted.

In the method for preparing an electrophoretic particle of the invention, it is preferable that the particle adsorbing group is at least one selected from an anionic group, a cationic group, and a nonionic group.

Thus, the particle adsorbing group can be imparted with electrostatic adsorbability onto the surface of the particle.

In the method for preparing an electrophoretic particle of the invention, it is preferable that at least the one kind of monomers includes fourth monomers having the crosslinking groups provided with adsorbability, and in the process of obtaining the plurality of block copolymers, the crosslinking/adsorbing portions are formed by the polymerization of the fourth monomers.

Thus, even though the base particles are those having no functional group on the surface thereof, irrespective of the kind of the base particles, the block copolymers can be fixed on the surface of the particles.

In the method for preparing an electrophoretic particle of the invention, it is preferable that the at least one kind of monomers includes fifth monomers having the crosslinking groups and the particle adsorbing group provided with adsorbability, and in the process of obtaining the plurality of block copolymers, the crosslinking/adsorbing portions are formed by the polymerization of the fifth monomers.

Thus, even though the base particles are those having no functional group on the surface thereof, irrespective of the kind of the base particles, the block copolymers can be fixed on the surface of the particles.

In the method for preparing an electrophoretic particle of the invention, it is preferable that the fifth monomers include two or more kinds of monomers, and in the process of obtaining the plurality of block copolymers, the crosslinking/adsorbing portions are formed by the polymerization of the two or more kinds of monomer.

Thus, even though the base particles are those having no functional group on the surface thereof, irrespective of the kind of the base particles, the block copolymers can be fixed on the surface of the particles.

In the method for preparing an electrophoretic particle of the invention, it is preferable that the living polymerization is reversible addition fragmentation chain transfer polymerization.

When the reversible addition fragmentation chain transfer polymerization is used, it is not necessary to use a catalyst, and accordingly, there is no concern about contamination. Further, the polymerization of the first monomers can be simply and conveniently carried out. Further, the molecular weight distribution in the dispersion portions can be adjusted to 1.2 or less.

In the method for preparing an electrophoretic particle of the invention, it is preferable that the plurality of block copolymers are isolated and purified before the process of adsorbing the crosslinking/adsorbing portions included in the plurality of block copolymers onto the surface of the particles.

Thus, the productivity of the obtained block copolymers can be improved.

In the method for preparing an electrophoretic particle of the invention, it is preferable that the adsorbability is electrostatic adsorbability onto the surface of the particles.

The electrophoretic particle of the invention has a particle and a coating layer covering at least a part of the particle, in which the coating layer includes a plurality of block copolymers having dispersion portions and crosslinking/adsorbing portions having crosslinking groups and being linked to the dispersion portions, the crosslinking/adsorbing portions are adsorbed onto the surface of the particles and the plurality of block copolymers are linked by a crosslinking agent in the crosslinking groups, the dispersion portions are formed by the polymerization of first monomers having functional groups contributing the dispersibility of the particles into a dispersion medium, and the crosslinking/adsorbing portions are formed by the polymerization of at least one kind of monomers, and thus provided with adsorbability onto the surface of the particles.

Thus, even though the base particles are those having no functional group on the surface thereof, irrespective of the kind of the base particles, electrophoretic particles in which the block copolymers are fixed on the surface of the particles can be obtained.

In the electrophoretic particle of the invention, it is preferable that the at least one kind of monomers includes second monomers having the crosslinking groups and third monomers having the particle adsorbing groups provided with adsorbability, and the crosslinking/adsorbing portions are formed by the copolymerization of the second monomers and the third monomers.

Thus, even though the base particles are those having no functional group on the surface thereof, irrespective of the kind of the base particles, electrophoretic particles in which the block copolymers are fixed on the surface of the particles can be obtained.

In the electrophoretic particle of the invention, it is preferable that the crosslinking/adsorbing portions are block copolymers including crosslinking portions formed by the polymerization of the second monomers and adsorbing portions formed by the polymerization of the third monomers.

Thus, even though the base particles are those having no functional group on the surface thereof, irrespective of the kind of the base particles, electrophoretic particles in which the block copolymers are fixed on the surface of the particles can be obtained.

In the electrophoretic particle of the invention, it is preferable that the adsorbing portion has 5 to 30 repeating units of the third monomers.

Thus, electrophoretic particles in which the adsorbing portions are assuredly adsorbed on the surface of the particles can be obtained.

In the electrophoretic particle of the invention, it is preferable that the crosslinking portion has 10 to 70 repeating units of the second monomers.

Thus, electrophoretic particles in which crosslinking portions provided in different random copolymers are assuredly bonded to each other by a crosslinking agent can be obtained.

In the electrophoretic particle of the invention, it is preferable that the crosslinking/adsorbing portions are random copolymers formed by the copolymerization of the second monomers and the third monomers.

Thus, even though the base particles are those having no functional group on the surface thereof, irrespective of the kind of the base particles, electrophoretic particles in which the block copolymers are fixed on the surface of the particles can be obtained.

In the electrophoretic particle of the invention, it is preferable that the at least one kind of monomers includes fourth monomers having the crosslinking groups provided with adsorbability, and the crosslinking/adsorbing portions are formed by the polymerization of the fourth monomers.

Thus, even though the base particles are those having no functional group on the surface thereof, irrespective of the kind of the base particles, electrophoretic particles in which the block copolymers are fixed on the surface of the particles can be obtained.

In the electrophoretic particle of the invention, it is preferable that the crosslinking/adsorbing portion has 10 to 70 repeating units of the fourth monomers.

Thus, the crosslinking/adsorbing portions provided with different random copolymers can be assuredly linked to each other by a crosslinking agent. Further, electrophoretic particles in which the crosslinking/adsorbing portions are assuredly adsorbed on the surface of the particles can be obtained.

In the electrophoretic particle of the invention, it is preferable that the crosslinking group is at least one of a hydroxyl group, primary to tertiary amino groups, a carboxyl group, a sulfone group, and a phosphone group.

Thus, the crosslinking/adsorbing portions provided with different random copolymers can be assuredly linked to each other by a crosslinking agent can be obtained. Further, electrophoretic particles in which the crosslinking/adsorbing portions are assuredly adsorbed on the surface of the particles can be obtained.

In the electrophoretic particle of the invention, it is preferable that the at least one kind of monomers includes fifth monomers having the crosslinking groups and the particle adsorbing group provided with adsorbability, and the crosslinking/adsorbing portions are formed by the polymerization of the fifth monomers.

Thus, even though the base particles are those having no functional group on the surface thereof, irrespective of the kind of the base particles, electrophoretic particles in which the block copolymers are fixed on the surface of the particles can be obtained.

In the electrophoretic particle of the invention, it is preferable that the crosslinking/adsorbing portion has 10 to 70 repeating units of the fifth monomers.

Thus, the crosslinking/adsorbing portions provided with different random copolymers can be assuredly linked to each other by a crosslinking agent can be obtained. Further, electrophoretic particles in which the crosslinking/adsorbing portions are assuredly adsorbed on the surface of the particles can be obtained.

In the electrophoretic particle of the invention, it is preferable that the fifth monomer is at least one of compounds represented by the following formulae (A1) to (A5).

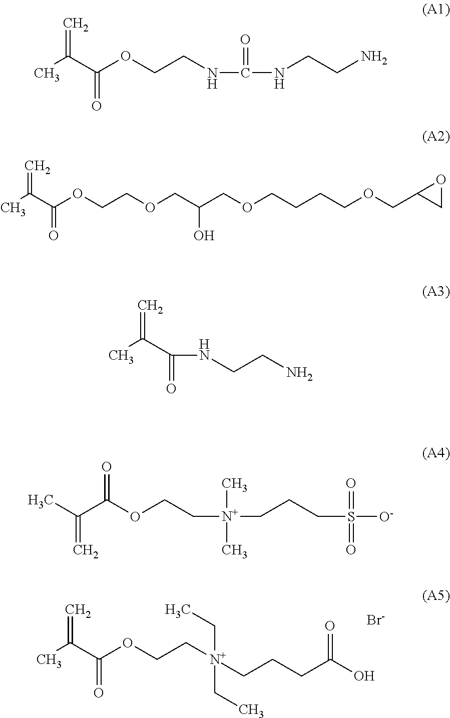

Thus, crosslinking/adsorbing portions provided with different random copolymers can be assuredly linked to each other by a crosslinking agent can be obtained. Further, electrophoretic particles in which the crosslinking/adsorbing portions are assuredly adsorbed on the surface of the particles can be obtained.

In the electrophoretic particle of the invention, it is preferable that the weight average molecular weight of the dispersion portions is from 20,000 to 100,000.

Thus, the dispersibility of the electrophoretic particles in an electrophoretic dispersion can further be improved.

In the electrophoretic particle of the invention, it is preferable that the first monomer is a silicone macromonomer represented by the following formula (I):

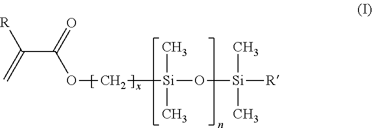

[wherein R represents a hydrogen atom or a methyl group, R′ represents a hydrogen atom or an alkyl group having 1 to 4 carbon atoms, n represents an integer of 0 or more, and x represents an integer of 1 to 3].

Thus, when a solvent having silicone oil as a main component is used as a dispersion medium included in the electrophoretic dispersion, the first monomers exhibit excellent affinity for the dispersion medium. Accordingly, the electrophoretic particles provided with the dispersion portions obtained by the polymerization of monomers M1 have excellent dispersibility. Thus, the dispersibility of the electrophoretic particles in the dispersion medium can further be improved.

In the electrophoretic particle of the invention, it is preferable that the molecular weight of the silicone macromonomer is from 1000 to 10000.

Thus, the electrophoretic particles provided with the dispersion portions obtained by the polymerization of the first monomers have a more excellent dispersibility. Thus, the dispersibility of the electrophoretic particles in the dispersion medium can further be improved.

In the electrophoretic particle of the invention, it is preferable that the adsorbability is electrostatic adsorbability onto the surface of the particle.

The electrophoretic dispersion of the invention may contain electrophoretic particles prepared by the method for preparing an electrophoretic particle of the invention or the electrophoretic particles of the invention.

Thus, an electrophoretic dispersion provided with electrophoretic particles which exhibit excellent dispersibility can be obtained.

The electrophoretic sheet of the invention may include a substrate, and a plurality of structures disposed on the top of the substrate, in which the plurality of structures stores the electrophoretic dispersion of the invention.

Thus, an electrophoretic sheet having high performance and reliability is obtained.

The electrophoretic apparatus of the invention may be provided with the electrophoretic sheet of the invention.

Thus, an electrophoretic apparatus having high performance and reliability is obtained.

The electronic device of the invention may be provided with the electrophoretic apparatus of the invention.

Thus, an electronic device having high performance and reliability is obtained.

### BRIEF DESCRIPTION OF THE DRAWINGS

The invention will be described with reference to the accompanying drawings, wherein like numbers reference like elements.

FIG. 1 is a vertical cross-sectional view showing an embodiment of the electrophoretic particle according to the invention.

FIG. 2 is a diagram schematically showing a polymer included in the electrophoretic particle shown in FIG. 1.

FIG. 3 is a diagram schematically showing a modified example of the polymer included in the electrophoretic particle shown in FIG. 1.

FIG. 4 is a diagram schematically showing another configuration example of the polymer included in the electrophoretic particle shown in FIG. 1.

FIG. 5 is a diagram schematically showing another configuration example of the polymer included in the electrophoretic particle shown in FIG. 1.

FIG. 6 is a diagram schematically showing another configuration example of the polymer included in the electrophoretic particle shown in FIG. 1.

FIG. 7 is a diagram schematically showing a vertical cross-sectional view of an embodiment of an electrophoretic display device.

FIGS. 8A and 8B are each a diagram schematically showing an operation principle of the electrophoretic display device shown in FIG. 7.

FIG. 9 is a perspective view showing an embodiment of a case where an electronic device of the invention is applied to an electronic paper.

FIGS. 10A and 10B are each a diagram showing to an embodiment a case where the electronic device of the invention is applied to a display.

FIG. 11 is a diagram schematically showing a vertical cross-sectional view of a structure in the electrophoretic particles in the related art.

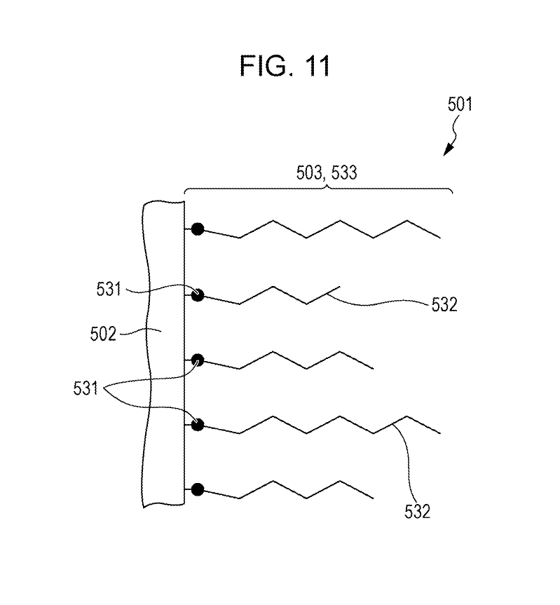

### DESCRIPTION OF EXEMPLARY EMBODIMENTS

Hereinafter, a detailed description will be given of a method for preparing an electrophoretic particle, electrophoretic particles, an electrophoretic dispersion, an electrophoretic sheet, an electrophoretic apparatus, and an electronic device of the invention based on preferable embodiments shown in the accompanying drawings.

First, prior to the description of the method for preparing an electrophoretic particle of the invention, electrophoretic particles prepared by such a preparation method (the electrophoretic particle of the invention) will be described.

### Electrophoretic Particles

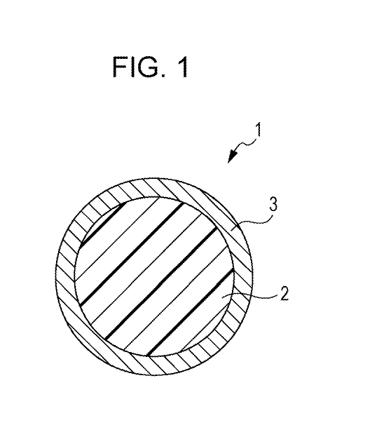

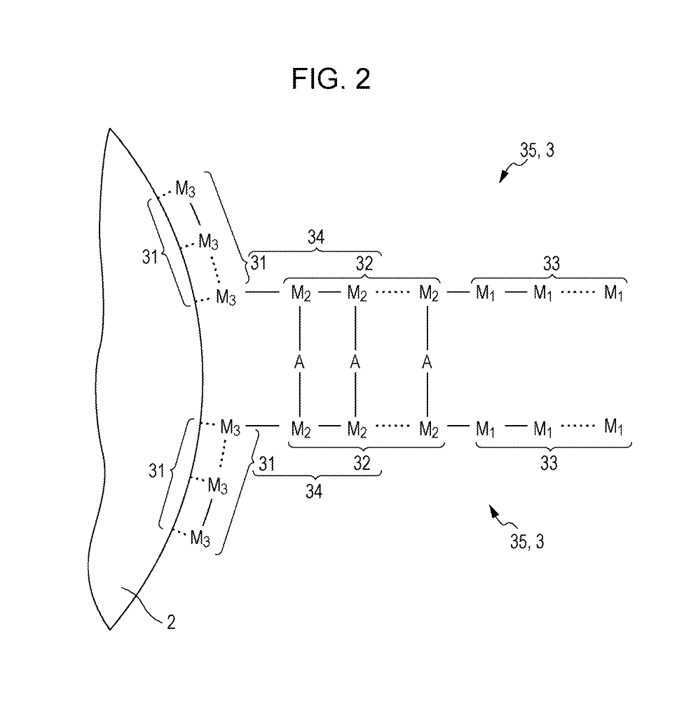

FIG. 1 is a vertical cross-sectional view showing an embodiment of the electrophoretic particle of the invention, and FIG. 2 is a diagram schematically showing a polymer included in the electrophoretic particle shown in FIG. 1.

An electrophoretic particle 1 has a mother particle 2 and a coating layer 3 provided on the surface of the mother particle 2.

For the mother particle (particle) 2, at least one kind from a pigment particle, a resin particle, and a composite particle thereof is preferably used, for example. These particles can be easily prepared.

Examples of the pigments configuring the pigment particle include black pigment such as aniline black, carbon black, and titan black, white pigment such as titanium dioxide, antimony trioxide, barium sulfate, zinc sulfide, zinc flower, and silicon dioxide, azo system pigment such as monoazo, disazo, and polyazo, yellow pigment such as isoindolinone, chrome yellow, yellow iron oxide, cadmium yellow, titan yellow, antimony, red pigment such as quinacridone red and chrome vermilion, blue pigment such as phthalocyanine blue, indanthrene blue, iron blue, ultramarine blue, and cobalt blue, green pigment such as phthalocyanine green. These may be used alone or in combination of two or more kinds thereof.

Furthermore, examples of the resin material constituting the resin particle include an acryl-based resin, a urethane-based resin, a urea-based resin, an epoxy-based resin, a polystyrene, and a polyester, and these may be used alone or in combination of two or more kinds thereof.

In addition, examples of the composite particle include a particle which has been subjected to a coating treatment by covering the surface of the pigment particle with the resin material, a particle which has been subjected to a coating treatment by covering the surface of the resin particle with the pigment, and a particle constituted with a mixture which has been obtained by mixing the pigment and the resin material at an appropriate composition ratio.

Incidentally, it is possible to attain a desired color of the electrophoretic particle 1 by appropriately selecting kinds of the pigment particle, the resin particle, and the composite particle, which are used as the mother particle 2.

Examples of the mother particle 2 include a particle provided with a functional group having reactivity, such as a hydroxyl group, a carboxyl group, and an amino group on the surface thereof, and particles not provided with such a functional group, according to the kind of the pigment particle, the resin particle, and the composite particle. For the electrophoretic particle 1, either of these two particles can be employed, but in the invention, the mother particle 2 not provided with a functional group on the surface thereof is particularly preferably employed. In other words, according to the invention, even in the case of the mother particle 2 not provided with a functional group, a coating layer 3 having a block copolymer 35 having a configuration as described later can be used as an electrophoretic particle 1 for at least a part of the surface of the mother particle 2. Further, the mother particle 2 not provided with a functional group on the surface thereof as described above is relatively often observed in particles having a surface constituted with organic materials among the pigment particles, the resin particles, and the composite particles.

At least a part of the surface of the mother particle 2 (almost entire surface of the configuration shown in the drawing) is covered with the coating layer 3.

In the invention, the coating layer 3 includes a plurality of block copolymers 35 (hereinafter also simply referred to as a “polymer 35”) provided with dispersion portions 33 and crosslinking/adsorbing portions 34. After the polymerization, the dispersion portions 33 are formed by the polymerization of first monomers M1 (hereinafter also simply referred to as “monomers M1”) having functional groups which will become side chains (dispersion side chains) contributing to the dispersibility of the electrophoretic particles 1 into a dispersion medium, after the polymerization. The crosslinking/adsorbing portions 34 are constituted with polymers having crosslinking groups and being provided with adsorbability onto the surface of the mother particles 2. These polymers are formed by the polymerization of at least one kind of monomers. In the present embodiment, the polymers are constituted with block copolymers formed by the copolymerization of second monomers M2 (hereinafter also simply referred to as “monomers M2”) having crosslinking groups and third monomers M3 (hereinafter also simply referred to as “monomers M3”) having functional groups which will become a side chain (adsorption side chain) provided with electrostatic adsorbability onto the surface of the mother particles 2. Incidentally, a site derived from the monomers M1 is referred to as a dispersion unit, a site derived from the monomers M2 is referred to as a crosslinking unit, and a site derived from the monomers M3 is referred to as an adsorbing unit, in the polymers 35 hereinafter. For the polymers 35, by the electrostatic adsorbability of the adsorption side chains included in the adsorbing unit onto the surface of the mother particles 2, the crosslinking/adsorbing portions 34 are adsorbed onto the surface of the mother particles 2. Further, different polymers 35 are linked through a crosslinking agent A in the crosslinking groups included in the crosslinking unit, thereby fixing the polymers 35 around the mother particles 2.

In the polymers 35 provided in the coating layer 3, in the present embodiment, the crosslinking/adsorbing portions 34 are constituted with block copolymers including crosslinking portions 32 which are formed by the homopolymerization of the monomers M2 and having an end linked to the dispersion portions 33, and adsorbing portions 31 which are formed by the homopolymerization of the monomers M3 and linked to the other end of the crosslinking portions 32. In these polymers 35, the adsorbing portions 31 are adsorbed onto the surface of the mother particles 2 in the adsorption side chains, and the crosslinking portions 32 are linked to each other through a crosslinking agent A in the crosslinking group, and thus, a plurality of polymers 35 are fixed in the mother particle 2 (see FIG. 2).

The dispersion portions 33 are provided by being exposed on the surface of the mother particles 2 in the coating layer 3 in order to provide the electrophoretic particle 1 with dispersibility in the electrophoretic dispersion as described later.

This dispersion portions 33 are constituted with polymers formed by multiple polymerization (homopolymerziation) of the monomers M1 having functional groups which will become side chains contributing the dispersibility of the electrophoretic particles 1 in the dispersion medium of the electrophoretic dispersion. By exposing the polymers derived from these monomers M1 on the surface of the mother particle 2 as the dispersion portions 33, the electrophoretic particle 1 can assuredly be provided with dispersibility.

The dispersion portions 33 configured as described above, that is, a significant number of the polymers formed by the multiple polymerization of the monomers M1 are exposed on the surface of the mother particles 2, but the molecular weight distribution of this dispersion portions 33 (polymer constituting the dispersion portions 33) is preferably 1.2 or less, more preferably 1.1 or less, and still more preferably 1.05 or less. The molecular weight distribution of the dispersion portions 33 represents a ratio of the number average molecular weight (Mn) of the dispersion portions 33 to the weight average molecular weight (Mw) of the dispersion portions 33 (Mw/Mn). Accordingly, if the molecular weight distribution of the dispersion portions 33 is no more than an upper limit, it can be said that the dispersion portions 33 exposed to a plurality of electrophoretic particles 1 has approximately uniform length. Thus, in the electrophoretic dispersion, each electrophoretic particle 1 can exhibit uniform dispersibility. This number average molecular weight (Mn) or the weight average molecular weight (Mw) can be measured as a molecular weight in terms of polystyrene by using, for example, a gel permeation chromatography (GPC) method.

The monomer M1 is a monofunctional monomer provided with one polymerization group capable of being polymerized in living radical polymerization, and constituting a pendant type provided with a site which will be a nonionic side chain after polymerization.

By using a monomer provided with a functional group which will be a nonionic side chain as the monomer M1, the dispersion portion 33 formed in living radical polymerization exerts excellent affinity for the dispersion medium included in the electrophoretic dispersion as described later. In doing so, in the electrophoretic dispersion, the electrophoretic particle 1 provided with the dispersion portion 33 is not aggregated and can be dispersed with excellent dispersibility. That is, this nonionic side chain exerts a function as a dispersed side chain contributing the dispersibility of the electrophoretic particle 1 in the dispersion medium of the electrophoretic dispersion.

Furthermore, examples of the polymerization group included in the monomer M1 include a group containing a carbon-carbon double bond, such as a vinyl group, a styryl group, and a (meth)acryloyl group.

Examples of such a monomer M1 include a vinyl monomer, a vinyl ester monomer, a vinyl amide monomer, a (meth)acryl monomer, a (meth)acryl ester monomer, a (meth)acrylamide monomer, and a styryl monomer, and specifically, acryl-based monomers such as a silicone macromonomer represented by the following general formula (I), such as 1-hexene, 1-heptene, 1-octene, methyl (meth)acrylate, ethyl (meth)acrylate, propyl (meth)acrylate, stearyl (meth)acrylate, lauryl (meth)acrylate, decyl (meth)acrylate, isooctyl (meth)acrylate, isobornyl (meth)acrylate, cyclohexyl (meth)acrylate, and pentafluoro(meth)acrylate, and styrene-based monomers such as styrene, 2-methyl styrene, 3-methyl styrene, 4-methyl styrene, 2-ethyl styrene, 3-ethyl styrene, 4-ethyl styrene, 2-propyl styrene, 3-propyl styrene, 4-propyl styrene, 2-isopropyl styrene, 3-isopropyl styrene, 4-isopropyl styrene, and 4-tert-butyl styrene. These may be used alone or in combination of two or more kinds thereof.

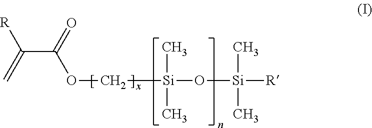

[wherein R represents a hydrogen atom or a methyl group, R′ represents a hydrogen atom or an alkyl group having 1 to 4 carbon atoms, n represents an integer of 0 or more, and x represents an integer of 1 to 3.]

Among these, as the monomer M1, a silicone macromonomer represented by the general formula (I) is preferred. In the case of adopting such a monomer M1, when a solvent having a silicone oil as a main component is used as a dispersion medium in the electrophoretic dispersion as described later, the monomer M1 represents excellent affinity for the dispersion medium. In doing so, the electrophoretic particle 1 provided with the dispersion portion 33 obtained by the polymerization of the monomers M1 has excellent dispersibility. Thus, the dispersibility of the electrophoretic particles 1 in the dispersion medium can further be improved.

The molecular weight of the silicone macromonomer is approximately preferably from 1000 to 10000, and more preferably from 3000 to 8000. Thus, the electrophoretic particles 1 provided with the dispersion portion 33 obtained by the polymerization of the monomers M1 have superior dispersibility. Thus, the dispersibility of the electrophoretic particles 1 in the dispersion medium can further be improved.

Furthermore, the weight average molecular weight of the dispersion portions 33 is preferably from 20,000 to 100,000, and more preferably from 30,000 to 60,000. In particular, in the case of using the silicone macromonomer represented by the general formula (I) as the monomer M1, the weight average molecular weight of the dispersion portions 33 is preferably from 30,000 to 70,000, and more preferably from 45,000 to 55,000. Thus, the dispersibility of the electrophoretic particles 1 in the electrophoretic dispersion can further be improved.

Furthermore, in the case where for the monomers M1, a solvent having aliphatic hydrocarbons (fluidized paraffin) as a main component is used as a dispersion medium in the electrophoretic dispersion as described later, it is preferable to use a monomer having an alkyl group as a functional group which will be a nonionic side chain. Since such a monomer M1 exhibits excellent affinity for the dispersion medium, the electrophoretic particle 1 provided with the dispersion portion 33 obtained by the polymerization of the monomers M1 has excellent dispersibility. Thus, the dispersibility of the electrophoretic particles 1 in the dispersion medium can further be improved.

Furthermore, it is preferable that the molecular weight of the monomer M1 on the proximal end side linked to the crosslinking/adsorbing portion 34 is smaller than that of the monomer M1 on the distal end side in the dispersion portion 33. More specifically, it is preferable that the molecular weight of the side chain provided in the monomer M1 which will be a precursor of a dispersion unit positioned on the proximal end side is smaller than the molecular weight of the side chain provided in the monomer M1 which will be a precursor of a dispersion unit positioned on the distal end side. Thus, the dispersibility of the electrophoretic particles 1 in the electrophoretic dispersion can further be improved, and at the same time, the dispersion portion 33 can be linked to the surface of the mother particle 2 at a high density.

Furthermore, the change in the molecular weight of such a side chain may be increased continuously in the direction from the proximal end side to the distal end side, and may be increased gradually in the direction from the proximal end side to the distal side.

In the present embodiment, the crosslinking/adsorbing portion 34 is constituted with a block copolymer including a crosslinking portion 32 and an adsorbing portion 31 as described above. In this crosslinking/adsorbing portion 34, the adsorbing portion 31 is involved in adsorption onto the surface of the mother particle 2 and the crosslinking portion 32 is involved in the linking by a crosslinking agent A.

The adsorbing portion 31 is adsorbed onto the surface of the mother particle 2 in the coating layer 3 provided in the electrophoretic particle 1, and further, different polymers 35 are linked to each other by a crosslinking agent in the crosslinking portion 32 as described later. Thus, the polymer 35 is fixed around the mother particle 2.

In the present embodiment, this adsorbing portion 31 is constituted with a polymer formed by the multiple polymerization (homopolymerization) of the third monomers M3 having a functional group (particle adsorbing group) which will become an adsorption side chain provided with electrostatic adsorbability on the surface of the mother particle 2.

Thus, the surface of the mother particle 2 is involved with the adsorbing portion 31 having an adsorption side chain. That is, even in the case of being not provided with a functional group capable of being covalently bonded with the surface of the mother particle 2, in the electrophoretic particle 1 provided with an adsorbing portion 31 having a plurality of adsorbing units having adsorption side chains provided with electrostatic adsorbability, the polymer 35 can be bonded (adsorbed) with the surface of the mother particle 2.

The monomer M3 is a pendant type of a monomer which is provided with one polymerization group so as to be polymerized in living radical polymerization and has a functional group which will be an adsorption side chain provided with electrostatic adsorbability onto the surface of the mother particle 2. Further, the number of the functional groups which will become adsorption side chain included in the monomer M3 may be one, or two or more.

Furthermore, examples of the one polymerization group included in the monomer M3 include the same functional groups mentioned for the monomer M1, and examples thereof include functional groups including carbon-carbon double bonds, such as a vinyl group, a styryl group, and a (meth)acryloyl group.

Furthermore, the functional group which will become an adsorption side chain included in the monomer M3 is selected from functional groups containing an anionic group, a cationic group, and a nonionic polar group (nonionic group), according to the acidity or basicity of the surface of the mother particle 2, that is, the electric chargeability for charging positively or negatively the surface of the mother particle 2. That is, in the case of positively charging the surface of the mother particle 2, a functional group having a negatively polar anionic or nonionic group is selected as the adsorption side chain, and in the case of negatively charging the surface of the mother particle 2, a functional group having a positively charged cationic or nonionic group is selected as the adsorption side chain.

Examples of such the adsorption side chain include anionic groups such as a sulfone group and a carboxyl group, amines and salts thereof; cationic groups such as a quaternary ammonium salt; and nonionic groups such as a hydroxyl group, an ether group, a phenyl group, an ester group, an amide group, and an aromatic ring, and these may be used alone or in combination of two or more kinds thereof. The aromatic ring may be a ring having an aromatic hydrocarbon as a basic skeleton, or may be a ring having an aromatic heterocyclic compound as a basic skeleton. These may be monocyclic or fused rings.

Examples of these monomers M3 include a vinyl monomer, a vinyl ester monomer, a vinyl amide monomer, a (meth)acryl monomer, a (meth)acryl ester monomer, a (meth)acrylamide monomer, and a styryl monomer, each provided with one adsorption side chain having an anionic, cationic, or nonionic polar group, more specifically, 2-hydroxyethyl (meth)acrylate, 2-hydroxypropyl (meth)acrylate, polyethylene glycol mono(meth)acrylate, glycerol mono(meth)acrylate, dicyclopentanyl (meth)acrylate, phenyl (meth)acrylate, benzyl (meth)acrylate, (meth)acrylamide, 1-naphthyl (meth)acrylate, pentabromophenyl (meth)acrylate, 1-pyrenemethyl (meth)acrylate, 2,4,6-tribromophenyl (meth)acrylate, pentafluorophenyl (meth)acrylate, furfuryl (meth)acrylate, tetrahydrofurfuryl (meth)acrylate, glycoloxyethyl (meth)acrylate, ethylene glycol phenylether (meth)acrylate, triethylene glycol methyl ether (meth)acrylate, N-methylol (meth)acrylamide, styrene, α-methylstyrene, aminomethyl (meth)acrylate, aminoethyl (meth)acrylate, N,N-dimethylaminoethyl (meth)acrylate, 2-(diisopropylamino)ethyl methacrylate, N-ethyl-N-phenylaminoethyl (meth)acrylate, N,N-dimethyl (meth)acrylamide, N,N-diethyl (meth)acrylamide, 2-(diethylamino)ethyl methacrylate, 4-vinylpyridine, (meth)acrylic acid, carboxymethyl (meth)acrylate, carboxyethyl (meth)acrylate, vinylbenzoic acid, vinylphenylacetic acid, vinylphenylpropionic acid, vinylsulfonic acid, sulfomethyl (meth)acrylate, 2-sulfoethyl (meth)acrylate, 9H-carbazole-9-ethyl (meth)acrylate, ferrocenylmethyl (meth)acrylate, potassium 3-sulfopropyl (meth)acrylate, 2-aminoethyl (meth)acrylate hydrochloride, and [3-((meth)acryloylamino)propyl]dimethyl(3-sulfopropyl)ammonium hydroxide, intramolecular salts. The adsorbing portion 31 may be a homopolymer formed by using one kind thereof or a combination of two or more kinds there.

Furthermore, the number of the adsorbing units included in the adsorbing portion 31, that is, the number of the monomers M3 to be polymerized when the adsorbing portion 31 is formed, in one polymer 35, is preferably from 5 to 30, and more preferably from 10 to 20. When the number of the adsorbing portions is more than the upper limit, the affinity of the adsorbing portion 31 for the dispersion medium is lower than that of the dispersion portion 33 for the dispersion medium, and therefore, there is a concern that depending on the kind of the monomer M3, the dispersibility of the electrophoretic particles 1 may be lowered or the adsorbing portions 31 may be partially reacted with each other. In addition, when the number of the adsorbing portions is less than the lower limit, there is a concern that depending on the kind of the monomer M3, the adsorption onto the mother particle 2 does not proceed sufficiently, and thus, the dispersibility of the electrophoretic particles 1 may be lowered.

Moreover, the number of the bonding units included in the adsorbing portion 31 can be determined by analysis using generally used analyzers such as an NMR spectrum, an IR spectrum, elemental analysis, and gel permeation chromatography (GPC). In the polymer 35, since the adsorbing portion 31 is a high-molecular weight polymer, it has a predetermined molecular weight distribution. Accordingly, the results of the above-described analysis cannot be said to correspond to the polymer 35 in all the cases, but at least if the number of the adsorbing units as determined by the method above is from 5 to 30, the adsorption property of the polymer 35 and the mother particle 2, and the dispersibility of the electrophoretic particles 1 can be satisfied at the same time.

Such the polymer 35 is obtained by the preparation method as described later. For example, when the reversible addition fragmentation chain transfer polymerization (RAFT) is used as described later, relatively uniform polymers can be obtained. Accordingly, when polymerization is carried out by adding 5 molar equivalents to 30 molar equivalents of the monomers M3 with respect to the chain transfer agent, the number of the bonding units in the adsorbing portion 31 can be set to the above range. In the case where the conversion rate of the monomers M3 is 100% or less, taking this into consideration, the polymerization reaction may be carried out with an addition amount of the monomers M3 of no less than 5 molar equivalents to 30 molar equivalents.

The crosslinking portion 32 is a site provided for binding the different polymers 35 in the coating layer 3 provided in the electrophoretic particle 1. The crosslinking portions provided in the different polymers 35 through the crosslinking agent A are linked to each other, and further, the adsorbing portion 31 as described above is adsorbed on the surface of the mother particle 2, and thus, the polymer 35 is fixed around the mother particle 2.

In the present embodiment, this crosslinking portion 32 is constituted with polymers formed by the multiple polymerization (homopolymerization) of the second monomers M2 having a crosslinking group. Further, in the crosslinking portion 32 with such a configuration, the crosslinking portions 32 included in the different polymers 35 are linked to each other through the crosslinking agent A.

Thus, since the crosslinking portion 32 is formed by the multiple polymerization of the second monomers M2 included in the crosslinking group, a plurality of crosslinking groups may be involved in the mutual linking of the crosslinking portions 32 through the crosslinking agent A. In doing so, the different polymers 35 can be assuredly linked to each other in the crosslinking portion 32. Thus, the polymers 35 are adsorbed on the surface of the mother particle 2 in the adsorbing portion 31 as described above, but in this state, the polymers 35 can be fixed more firmly. Therefore, the dispersibility and the long-term stability of the electrophoretic particle 1 can be improved.

Furthermore, in the present embodiment, the polymers 35 are approximately uniformly adsorbed on the surface of the mother particle 2, and these polymers 35 are linked to each other through the crosslinking agent A. That is, the mother particle 2 is covered with a shell formed by the crosslinking of the crosslinking portions 32 by the crosslinking agent A. Thus, the polymers 35 can be prevented from being peeled from the surface of the mother particle 2. In addition, even when a part of the mother particle 2 is peeled or the mother particle itself collapses, an effect that a part of the peeled mother particle or the collapsed mother particle is stored inside the shell can be expected. Thus, the dispersibility or long-term stability of the electrophoretic particle 1 can be prevented from being reduced. Further, the peeling or collapse of the mother particle 2 is relatively often observed in pigment particles formed of organic materials. Accordingly, the invention is particularly effective for pigment particles in which the mother particles 2 are formed of organic materials, but it is also effective for mother particles 2 formed of other materials.

The monomer M2 is a pendent type monomer which is provided with one polymerization group capable of polymerizing in living radical polymerization, and has a crosslinking group which is crosslinked with another crosslinking group through a crosslinking agent A. Further, the number of the crosslinking groups in the monomer M2 may be one or two or more.

Furthermore, examples of the one polymerization group included in the monomer M2 include the same functional groups mentioned for the monomer M1, and examples thereof include functional groups including carbon-carbon double bonds, such as a vinyl group, a styryl group, and a (meth)acryloyl group.

Furthermore, as the crosslinking group included in the monomers M2, a functional group having the reactivity with a functional group provided in the crosslinking agent A is selected.

A combination of the crosslinking group included in the monomer M2 and the functional group provided in the crosslinking agent A is not particularly limited as long as the functional groups capable of being reacted with each other and crosslinked, and may be a combination of general functional groups having crosslinkability, such as (A) organic oxides, phenols, alcohols, aldehydes, epoxy compounds, isocyanates, and carboxylic acids, (B) sulfur analogues of the compounds mentioned in (A), (C) sulfur, amines, quinone, halogen, aziridine compounds, azo compounds, acid anhydrides, borohyride, boric acid, and phosphorous compounds. Examples of the combination include a combination of a chlorosulfone group with a hydroxyl group, a combination of an isocyanate group with a hydroxyl group, an amino group, a thiol group, a carboxyl group, a phenolic hydroxyl group, or a nitrile group, a combination of an epoxy group, a glycidyl group, or an oxetane group with a carboxyl group, an amino group, a thiol group, a hydroxyl group, a phenolic hydroxyl group, an isocyanate group, an acid anhydride, chlorosulfone, or an imidazole group, a combination of an oxazoline group with a carboxyl group, a combination of an amino group or a pyridine group with a halogen group such as Cl, Br, and I, a combination of an alkoxysilyl group with a hydroxyl group or with an alkoxysilyl group. Among these groups, the crosslinking group is an epoxy group, and the functional group provided in the crosslinking agent A is preferably a combination of a carboxyl group, an amino group, a thiol group, a hydroxyl group, or an imidazole group.

The monomer M2 having a crosslinking group and the crosslinking agent A, included in the combination, can each be relatively easily prepared and the monomers M2 can be firmly bonded to each other through the crosslinking agent A, and thus, this combination is preferably used.

Examples of the monomer M2 include a vinyl monomer, a vinyl ester monomer, a vinyl amide monomer, a (meth)acryl monomer, a (meth)acryl ester monomer, a (meth)acrylamide monomer, and a styryl monomer, each provided with one epoxy group as a crosslinking group, and more specifically glycidyl (meth)acrylate, β-methylglycidyl (meth)acrylate, 3,4-epoxycyclohexyl methyl (meth)acrylate, 3,4-epoxycyclohexylethyl (meth)acrylate, 3,4-epoxycyclohexylpropyl (meth)acrylate, and aryl glycidyl ether, and these may be used alone or in combination of two or more kinds thereof.

Furthermore, examples of the crosslinking agent A include bifunctional or higher acid anhydrides, polyamine compounds, phenol compounds, diol compounds, thiol compounds, and imidazole compounds, and these may be used alone or in combination of two or more kinds thereof. By using such a compound as the crosslinking agent A, it is possible to form a linked structure by the reaction with an epoxy group, thereby assuredly linking the crosslinking groups to each other through the crosslinking agent A.

Particularly, at least one of a polyamine compound and a diol compound is preferred among them. Since such a compound can be easily handled and has high reactivity, it is possible to more assuredly link the crosslinking groups to each other.

Moreover, specific examples of the crosslinking agent include chain aliphatic polyamines such as diethylenetriamine, triethylenetetramine, tetraethylenepentamine, dipropylenediamine, and diethylaminopropylamine, cyclic aliphatic polyamines such as N-aminoethylpiperazine, menthenediamine, and isophoronediamine, aliphatic-aromatic amines such as m-xylylenediamine, sho-amine X, amine black, and sho-amine black, aromatic amines such as metaphenylenediamine, diaminodiphenylmethane, and diaminodiphenylsulfone, acid anhydrides such as phthalic anhydride, trimellitic anhydride, pyromellitic anhydride, benzophenonetetracarboxylic anhydride, ethylene glycol bistrimellitate, glycerol tristrimellitate, maleic anhydride, tetrahydrophthalic anhydride, succinic anhydride, methylcyclohexene dicarboxylic anhydride, an alkylstyrene-maleic anhydride copolymer, chlorendic anhydride, and polyazelaic anhydride, and diol compounds such as 1,6-hexane diol and polyethylene glycol.

Furthermore, in the case where the crosslinking agent A is provided with two functional groups and a main chain linking these functional groups, and this main chain is a crosslinking agent constituted with an alkylene group, the number of carbon atoms included in the alkylene group is preferably from 4 to 20, and more preferably from 6 to 10. Thus, the polymers 35 can be linked to maintain a distance suitable for the dispersibility or the long-term stability. Further, in the crosslinking portion 32 included in the adjacent polymers 35, the crosslinking groups included in the crosslinking unit can be assuredly linked to each other through the crosslinking agent A.

Incidentally, in the adjacent polymers 35, it is not necessary for the crosslinked structure formed by linking the crosslinking groups included in the crosslinking portion 32 by the crosslinking agent to be formed in each of the crosslinking units provided in the crosslinking portion 32. At least one of such the crosslinked structure may be formed in the crosslinking portion 32 of each polymer 35.

Furthermore, the number of the crosslinking units included in the crosslinking portion 32, that is, the number of the monomers M2 to be polymerized when the crosslinking portion 32 is formed, in one polymer 35, is preferably from 10 to 70, and more preferably from 20 to 60. When the number of the crosslinking units is more than the upper limit, the affinity of the crosslinking portion 32 for the dispersion medium is lower than that of the dispersion portion 33 for the dispersion medium, and therefore, there is a concern that depending on the kind of the monomer M2, the dispersibility of the electrophoretic particles 1 may be lowered. In addition, when the number of the crosslinking units is less than the lower limit, there is a concern that depending on the kind of the monomer M2, the mutual bonding of the crosslinking groups does not proceed sufficiently, and thus, the dispersibility of the electrophoretic particles 1 may be lowered.

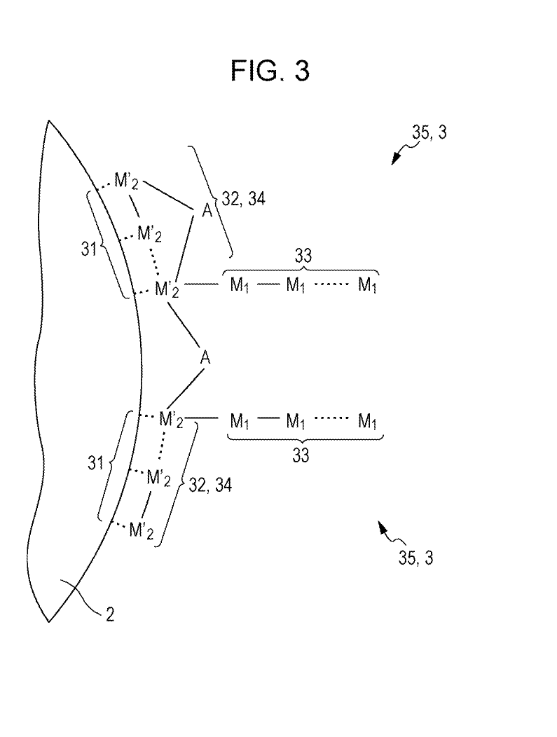

Furthermore, in the case where the crosslinking group is provided with electrostatic adsorbability onto the surface of the mother particle 2, the crosslinking group can exert a function as an adsorption side chain provided in the adsorbing unit as described above. In this case, the crosslinking portion 32 can be provided with a function as the adsorbing portion 31. Accordingly, in the case of using a fourth monomer M2′ (hereinafter also simply referred to as a “monomer M2′”) having a crosslinking group provided with electrostatic adsorbability onto the surface of the mother particle 2 to synthesize a crosslinking/adsorbing portion 34, it can be omitted to form the adsorbing portion 31 in the polymer 35 (see FIG. 3). Thus, examples of the crosslinking group provided with electrostatic adsorbability with respect to the mother particle 2 include a hydroxyl group, primary to tertiary amines (amino groups), a carboxyl group, a sulfone group, and a phosphone group.

In the case where the crosslinking/adsorbing portion 34 is synthesized using the monomer M2′, the number of the crosslinking/adsorbing units in the crosslinking/adsorbing portion 34, that is, the number of the monomers M2′ to be polymerized when the crosslinking/adsorbing portion 34 is formed, in one polymer 35, is preferably from 15 to 100, and more preferably from 30 to 80.

Moreover, the number of the crosslinking units included in the crosslinking portion 32 and the number of the crosslinking/adsorbing units included in the crosslinking/adsorbing portion 34 can be determined by analysis using generally used analyzers such as an NMR spectrum, an IR spectrum, elemental analysis, and gel permeation chromatography (GPC). In the polymer 35, since the crosslinking portion 32 and the crosslinking/adsorbing portion 34 are high-molecular weight polymers, they have a predetermined molecular weight distribution. Accordingly, the results of the above-described analysis cannot be said to correspond to the polymer 35 in all the cases, but at least if the number of the crosslinking units and the number of the crosslinking/adsorbing units as determined by the method above is within the above range, the adsorption property of the polymer 35 and the mother particle 2, the dispersibility of the electrophoretic particles 1, and the long-term stability can be satisfied at the same time.

The polymer 35 is obtained by the preparation method as described later. For example, when reversible addition fragmentation chain transfer polymerization (RAFT) is used as described later, a relatively uniform polymer can be used. Accordingly, when polymerization is carried out by adding 10 molar equivalents to 70 molar equivalents of the monomers M2 with respect to the chain transfer agent, the number of the crosslinking units in the crosslinking portion 32 can be set to the above range. In the case where the conversion rate of the monomers M2 is 100% or less, taking this into consideration, the polymerization reaction may be carried out with an addition amount of the monomers M2 of no less than 10 molar equivalents to 70 molar equivalents. When polymerization is carried out by adding 15 molar equivalents to 100 molar equivalents of the monomers M2′ with respect to the chain transfer agent, the number of the crosslinking/adsorbing units in the crosslinking/adsorbing portion 34 can be set to the above range. In the case where the conversion rate of the monomers M2′ is 100% or less, taking this into consideration, the polymerization reaction may be carried out with an addition amount of the monomers M2′ of no less than 15 molar equivalents to 100 molar equivalents.

Furthermore, the crosslinking portion 32 with such a configuration has its thickness set to preferably from about 5 nm to about 20 nm, and more preferably from about 7 nm to 14 nm. Thus, since in the crosslinking portion 32, the crosslinking portions 32 included in the different polymers 35 can be firmly linked, the dispersibility of the electrophoretic particles 1 in the electrophoretic dispersion is improved.

Furthermore, in the present embodiment, the crosslinking/adsorbing portion 34 is constituted with a block copolymer including the crosslinking portion 32 and the adsorbing portion 31, but the invention is not limited to this configuration, and may have, for example, other configuration examples as shown below.

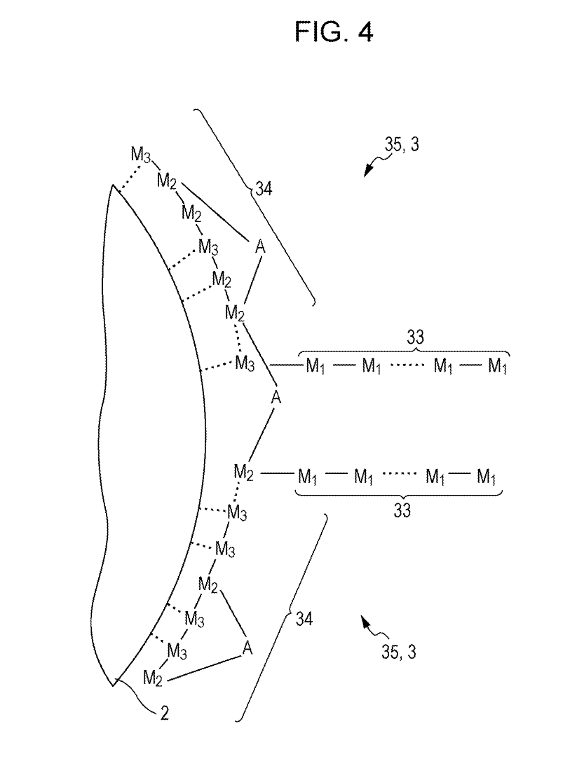

In other words, in other configuration examples, the crosslinking/adsorbing portion 34 is constituted with random copolymers formed by the copolymerization of the second monomers M2 and the third monomers M3 (see FIG. 4).

In the crosslinking/adsorbing portion 34 with such a configuration, the adsorbing unit constituting the random copolymer is involved in adsorption onto the surface of the mother particle 2, and further, the crosslinking unit constituting the random copolymer is involved in the linking through the crosslinking agent A.

As such, the crosslinking/adsorbing portion 34 is adsorbed onto the surface of the mother particle 2 by an action of the adsorbing unit in the coating layer 3 provided in the electrophoretic particle 1, and different polymers 35 are linked to each other through the crosslinking agent A in the crosslinking unit. Thus, the polymers 35 are fixed around the mother particle 2.

In the case where the crosslinking/adsorbing portion 34 is formed by random copolymerization of the monomers M2 and the monomers M3, the number of the crosslinking units included in the crosslinking/adsorbing portion 34 in one polymer 35 is preferably from 10 to 70, and more preferably from 20 to 60. The number of the adsorbing units is preferably from 5 to 30, and more preferably from 10 to 20.

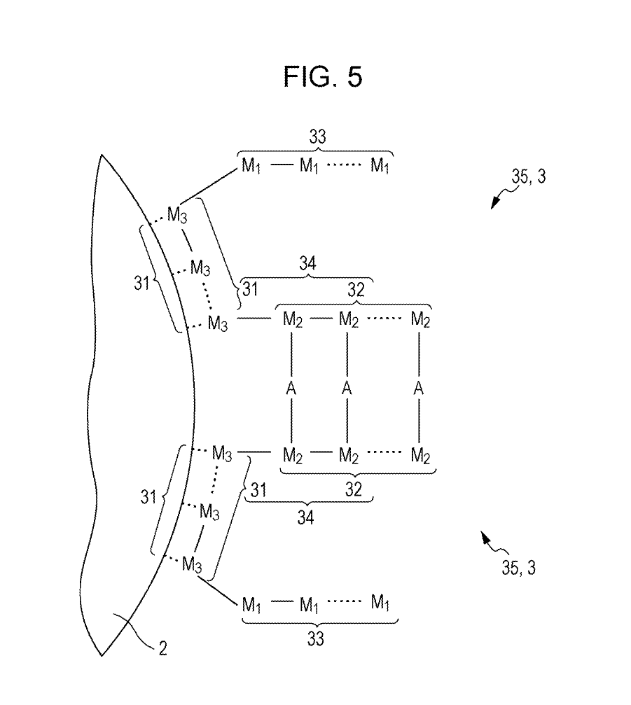

Alternatively, in the present embodiment, the polymer 35 is described above as a block copolymer in which the crosslinking portion 32 is positioned between the adsorbing portion 31 and the dispersion portion 33, but the invention is not limited to this configuration. The polymer 35 may be a block copolymer in which the adsorbing portion 31 is positioned between the crosslinking portion 32 and the dispersion portion 33 (see FIG. 5).

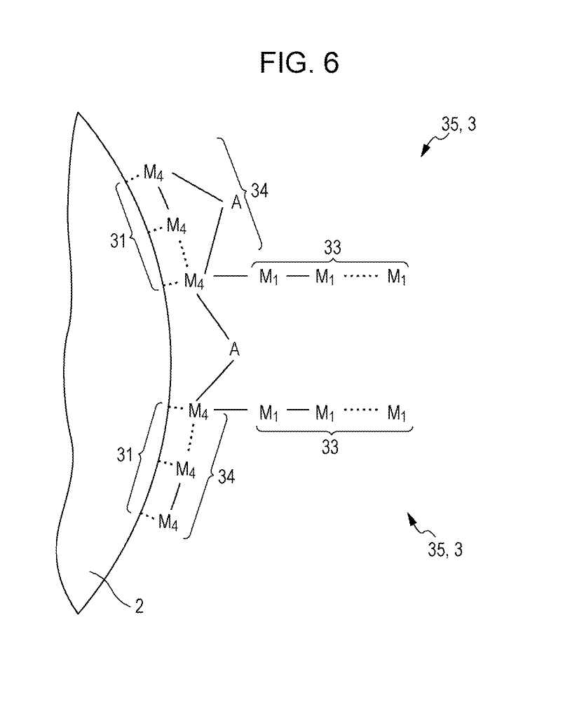

Moreover, in the present embodiment, a configuration where the crosslinking portion 32 is formed by the polymerization of the second monomers M2 and the adsorbing portion 31 is formed by the polymerization of third monomers M3 is described above, but the invention is not limited to this configuration. That is, in other configuration examples, a crosslinking/adsorbing portion 34 may be formed by the polymerization of one polymerization groups to be polymerized in living radical polymerization, a functional group which will become an adsorption side chain polymerization (particle adsorbing group), and a fifth monomer M4 provided with a crosslinking group (hereinafter also simply referred to as a “monomers M4”) (see FIG. 6). Examples of the functional group which will become an adsorption side chain of the monomers M4 include the functional groups exemplified as the functional group which will become an adsorption side chain included in the monomer M3, and further include the crosslinking groups exemplified as the crosslinking group of the monomer M2.

The monomer M4 can be obtained by, for example, reacting a monomer containing a polymerizable group and a site which will become a precursor of the adsorptive group (particle adsorbing group) with a monomer which is chemically bonded with the site which will be become a precursor of the adsorptive group to form an adsorptive group site and a crosslinking group, and examples of such the compound include compounds represented by the following formulae (A1) to (A3).

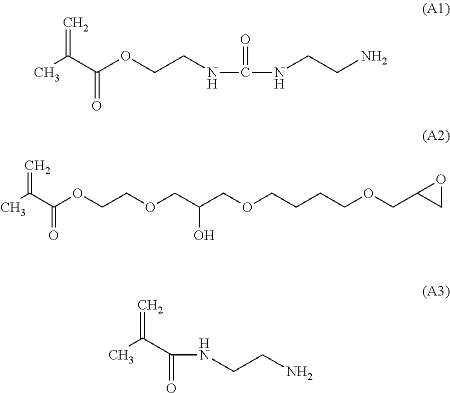

Alternatively, a compound obtained by the polymerization of a monomer A having a polymerizable group and an adsorptive group and a monomer B having a polymerizable group and a crosslinking group can be used as the monomer M4. At this time, the monomer M4 may be a block copolymer of the monomer A and the monomer B, or may be a random copolymer of the monomers.

Alternatively, the monomer M4 may be a monomer having an ionic group in the molecule as in the compounds represented by the following formulae (A4) and (A5).

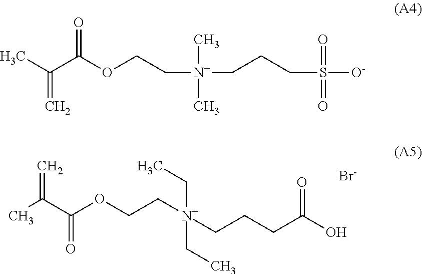 [SMILES: C=C(C)C(=O)OCC[N+](C)(C)CCCS(=O)(=O)[O-] ; C=C(C)C(=O)OCC[N+](CC)(CC)CCCC(=O)O ; [Br-]]

In addition to the compounds exemplified above, for example, a compound such as 4-chloromethylstyrene may be used.

In the crosslinking/adsorbing portion 34 formed by the polymerization of the compound above, any one of a positive ion and a negative ion can function as an adsorptive group and the other can function as a crosslinking group. As such, the crosslinking/adsorbing portion 34 may be formed by the polymerization of the monomer M4 provided with one or more crosslinking/adsorptive groups provided with the adsorbability with respect to the mother particle 2 and a function as the crosslinking group.

In the case where the crosslinking/adsorbing portion 34 is synthesized using the monomer M4, the number of the crosslinking/adsorbing units in the crosslinking/adsorbing portion 34, that is, the number of the monomers M4 to be polymerized when the crosslinking/adsorbing portion 34 is formed, in one polymer 35, is preferably from 15 to 100, and more preferably from 30 to 80.

In the crosslinking/adsorbing portion 34 in other configuration examples with such a configuration, a plurality of adsorbing units are involved in adsorption onto the surface of the mother particle 2, and therefore, the polymer 35 can be assuredly adsorbed onto the surface of the mother particle 2 in the crosslinking/adsorbing portion 34. Further, a plurality of the crosslinking units are involved in the mutual linking of different polymers 35 through the crosslinking agent A, and therefore, the different polymers 35 can be firmly linked to each other in the crosslinking/adsorbing portion 34.

As described above, the electrophoretic particle 1 can be prepared in, for example, the following manner.

### Method for Preparing Electrophoretic Particle

The method for preparing an electrophoretic particle 1 includes obtaining a plurality of block copolymers 35 having dispersion portions 33 and crosslinking/adsorbing portions 34 linked to each other; adsorbing the crosslinking/adsorbing portion 34 onto the surface of the mother particle 2 by the electrostatic adsorbability of the adsorption side chain included in the adsorbing unit with respect to the surface of the mother particle 2; and crosslinking the crosslinking groups included in the crosslinking unit through a crosslinking agent to link the different (adjacent) polymers 35 to each other, thereby forming a coating layer 3 in which a plurality of polymers 35 are fixed around the mother particles 2. Further, the process of obtaining a plurality of block copolymers includes forming a dispersion portion 33 by the polymerization of the monomers M1 having a functional group which will become a dispersion side chain in living radical polymerization using a polymerization initiator, and forming a crosslinking/adsorbing portion 34 by the copolymerization of the monomers M2 having a crosslinking group and the monomers M3 having a functional group which will become an adsorption side chain. In the process of obtaining the plurality of block copolymers, the crosslinking/adsorbing portion 34 may be formed after forming the dispersion portion 33, or a block copolymer 35 may be obtained after forming the crosslinking/adsorbing portion 34 and then forming the dispersion portion 33. In the case where the crosslinking/adsorbing portion 34 is a block copolymer, the crosslinking portion 32 may be formed after forming the adsorbing portion 31, or in reverse. In the case where the crosslinking/adsorbing portion 34 is a random copolymer, it may be formed collectively. In the present embodiment, a case where after the dispersion portion 33 is formed in the process of obtaining the plurality of block copolymers, a crosslinking portion 32 in which the monomers M2 are homopolymerized and an adsorbing portion 31 in which the monomers M3 are homopolymerized are formed in this order to obtain a block copolymer having the crosslinking portion 32 and the adsorbing portion 31 linked to each other will be described.

Hereinafter, each of the processes will be described in detail.

[1] First, a plurality of block copolymers 35 having the dispersion portions 33 and the crosslinking/adsorbing portions 34 linked to each other, that is, in the present embodiment, a plurality of block copolymers 35 in which the dispersion portion 33, the crosslinking portion 32, and the adsorbing portion 31 are linked in this order is produced (process of obtaining the plurality of block copolymers).

[1-1] First, a dispersion portion 33 in which first monomers M1 are polymerized by a living polymerization method using a polymerization initiator is formed.

Examples of the living polymerization method include living radical polymerization, living cation polymerization, and living anion polymerization, but among these, living radical polymerization is preferred. By carrying out living radical polymerization, a reaction liquid generated in a reaction system can be simply and conveniently used, and further, the monomers M1 can be polymerized with good reaction controllability. In addition, the molecular weight distribution in the dispersion portions 33 can be assuredly and easily set to 1.2 or less, and as a result, the obtained electrophoretic particle 1 can exert uniform dispersibility in the electrophoretic dispersion.

Furthermore, examples of the living radical polymerization method include atom transfer radical polymerization (ATRP), radical polymerization using nitroxide (NMP), radical polymerization (TERP) using organic tellurium, and reversible addition fragmentation chain transfer polymerization (RAFT), but among these, reversible addition fragmentation chain transfer polymerization (RAFT) is preferably used. According to the reversible addition fragmentation chain transfer polymerization (RAFT), a metal catalyst is not used, and therefore, there is no concern about metal contamination. Further, the polymerization during polymerization of the monomers M1 can be carried out simply and conveniently. Further, the molecular weight distribution in the dispersion portions 33 can be assuredly set to 1.2 or less.

The polymerization initiator (radical polymerization initiator) is not particularly limited, but examples thereof include azo-based initiators such as 2,2′-azobisisobutyronitrile (AIBN), 2,2′-azobis(4-methoxy-2,4-dimethylvaleronitrile), 2,2′-azobis(2,4-dimethylvaleronitrile), dimethyl 2,2′-azobis(2-methylpropionate), 1,1′-azobis(cyclohexane-1-carbonitrile), 2,2′-azobis[2-(2-imidazolin-2-yl)propane]dihydrochloride, and 2,2′-azobis[2-(2-imidazolin-2-yl)propane], and persulfates such as potassium persulfate, and ammonium per sulfate.

Furthermore, in the case of using reversible addition fragmentation chain transfer polymerization (RAFT), a chain transfer agent (RAFT agent) is used, in addition to the polymerization initiator. This chain transfer agent is not particularly limited, but examples thereof include sulfur compounds having a functional group such as a dithioester group, a trithiocarbamate group, a xanthate group, and a dithiocarbamate group.

Specific examples of the chain transfer agent include compounds represented by the following chemical formulae (1) to (7), and these may be used alone or in combination of two or more kinds thereof. These compounds are relatively easily available and the reaction thereof can be easily controlled, and therefore, are preferably used.

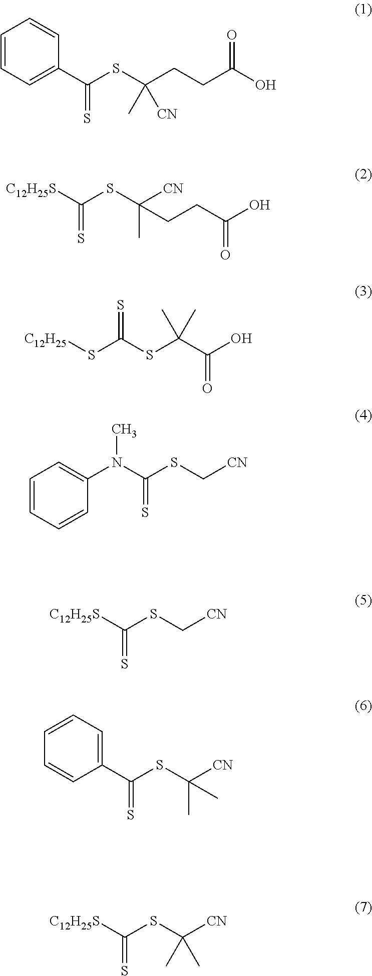

Among these, the chain transfer agent is preferably 2-cyano-2-propylbenzodithioate represented by the chemical formula (6). Thus, the reaction thereof can be more easily controlled.

Furthermore, in the case of using reversible addition fragmentation chain transfer polymerization (RAFT), the ratios of the monomers M1, the polymerization initiator, and the chain transfer agent are appropriately determined by taking into consideration the polymerization degree of the dispersion portions 33 to be formed, and the reactivity of compounds such as monomers M1, but this molar ratio is preferably as follows: monomers:polymerization initiator:chain transfer agent=500 to 5:5 to 0.25:1. Thus, the length (polymerization degree) of the dispersion portion 33 obtained by the polymerization of the monomers M1 can be set to an appropriate dimension. Further, by satisfying the conditions above, a dispersion portion 33 having a molecular weight distribution of 1.2 or less can be easily produced.

Furthermore, examples of a solvent used to prepare the solution for polymerization of the monomers M1 in living radical polymerization include water, alcohols such as methanol, ethanol, and butanol, hydrocarbons such as hexane, octane, benzene, toluene, and xylene, hydrocarbons such as octane, benzene, toluene, and xylene, ethers such as diethyl ether and tetrahydrofuran, and aromatic halogenated hydrocarbons such as chlorobenzene and o-dichlorobenzene, and these may be used alone or a mixed solvent thereof.

In addition, it is preferable that deoxidation of the solution (reaction solution) is carried out before initiating the polymerization reaction. Examples of the deoxidation treatment include substitution after vacuum deaeration with an inactive gas such as an argon gas and a nitrogen gas, and a purging treatment.

Incidentally, during the polymerization reaction of the monomers M1, the solution may be heated (warmed) to a predetermined temperature so that the polymerization reaction of the monomers can be more promptly and assuredly carried out.

This heating temperature varies depending on the kind of the monomers M1 or the like and is not particularly limited. However, it is preferably from about 30° C. to 100° C. In addition, the heating time (reaction time) is preferably from about 5 hours to 48 hours in the case of the heating temperature in the above range.

Moreover, when the reversible addition fragmentation chain transfer polymerization (RAFT) is used, a fragmentation of the chain transfer agent used exists on one end (distal end) of the dispersion portion 33. Further, the dispersion portion 33 provided with the fragmentation acts as a chain transfer agent in the reaction for polymerizing the crosslinking portion 32 with the dispersion portion 33 in the next process [1-2].

[1-2] Subsequently, as linked to the dispersion portion 33, a crosslinking portion 32 in which the second monomers M2 are polymerized is formed.

Thus, a block copolymer in which the adsorbing portion 31 is linked to the dispersion portion 33 is produced.

Furthermore, in the present process [1-2], a purification treatment (removal treatment) for isolating and purifying the dispersion portion 33 by removing impurities such as the unreacted monomers M1, the solvents, and the polymerization initiator used in the process [1-1] may be carried out, if necessary, before forming the crosslinking portion 32 using the monomer M2. Thus, a block copolymer with higher uniformity and higher purity can be obtained. This purification treatment is not particularly limited, but can be carried out by, for example, a column chromatography method, a recrystallization method, and reprecipitation method. These methods may be carried out alone or in combination of two or more kinds thereof.

In addition, when the reversible addition fragmentation chain transfer polymerization (RAFT) is used as described above, a fragmentation of the chain transfer agent used exists on one end of the dispersion portion 33. Thus, the process [1-1] is completed, a solution containing the obtained dispersion portion 33 and the monomers M2 is prepared, and living polymerization is carried out again in this solution, thereby forming a crosslinking portion 32.

Moreover, as a solvent used in the present process, the same solvent mentioned as in the process [1-1] may be used. Further, the condition for polymerization of the monomers M2 in the solvent can be the same as that for polymerization of the monomers M1 in the solution in the process [1-1].

Moreover, when the reversible addition fragmentation chain transfer polymerization (RAFT) is used, a fragmentation of the chain transfer agent used exists on one end (distal end) of the crosslinking portion 32 in the same manner as in the process [1-1]. Further, the crosslinking portion 32 provided with the fragmentation acts as a chain transfer agent in the reaction for polymerizing the adsorbing portion 31 with the crosslinking portion 32 in the next process [1-3].

[1-3] Subsequently, as in the linking to the crosslinking portion 32, the adsorbing portion 31 in which the third monomers M3 are polymerized is formed.

Thus, a polymer 35 constituted with a block copolymer in which the dispersion portion 33, the crosslinking portion 32, and the adsorbing portion 31 are linked in this order is produced.

Moreover, in the present process [1-3], a purification treatment (removal treatment) for isolating and purifying the polymer 35 by removing impurities such as the unreacted monomers M2, the solvents, and the polymerization initiator used in the process [1-2] may be carried out, if necessary, before forming the adsorbing portion 31 using the monomers M3. Thus, a block copolymer 35 having higher uniformity and higher purity can be obtained. This purification treatment is not particularly limited, but can be carried out by, for example, a column chromatography method, a recrystallization method, and reprecipitation method. These methods may be carried out alone or in combination of two or more kinds thereof.

In addition, when the reversible addition fragmentation chain transfer polymerization (RAFT) is used as described above, a fragmentation of the chain transfer agent used exists on one end of the crosslinked portion 32. Thus, the process [1-2] is completed, a solution containing the block copolymer including the obtained dispersion portion 33 and crosslinked portion 32, and the monomers M3 is prepared, and living polymerization is carried out again in this solution, thereby forming an adsorbing portion 31.

Moreover, as a solvent used in the present process, the same solvent mentioned as in the process [1-1] may be used. Further, the condition for polymerization of the monomers M3 in the solvent can be the same as that for polymerization of the monomers M1 in the solution in the process [1-1].

By carrying out the processes [1-1] to [1-3] as described above, a plurality of block copolymers 35 in which the dispersion portion 33 is linked to the crosslinking/adsorbing portion 34, that is, a plurality of block copolymers 35 in which dispersion portion 33, the crosslinking portion 32, and the adsorbing portion 31 are linked in this order in the present embodiment is produced.

Furthermore, in the case where the crosslinking/adsorbing portion 34 has another configuration example as described above, that is, a case where it is a random copolymer formed by the copolymerization of the second monomers M2 and the third monomers M3, by using the process [1-2′] as described later instead of the processes [1-2] and [1-3], a plurality of block copolymers 35 having the dispersion portion 33 and the crosslinking/adsorbing portion 34 linked to each other can be produced.

[1-2′] As linked to the dispersion portion 33, the crosslinking/adsorbing portion 34 constituted with a random copolymer in which the second monomers M2 and the third monomers M3 are copolymerized is formed.

Thus, the block copolymer 35 in which the crosslinking/adsorbing portion 34 is linked to the dispersion portion 33 is produced. Further, since the crosslinking/adsorbing portion 34 can be formed in one process as above, simplification of the processes can be promoted.

Furthermore, in the present process [1-2′], a purification treatment (removal treatment) for isolating and purifying the dispersion portion 33 by removing impurities such as the unreacted monomers M1, the solvents, and the polymerization initiator used in the process [1-1] may be carried out, if necessary, before forming the crosslinking/adsorbing portion 34 using the monomer M2 and the monomer M3. Thus, a block copolymer 35 having higher uniformity and higher purity can be obtained. This purification treatment is not particularly limited, but can be carried out by, for example, a column chromatography method, a recrystallization method, and a reprecipitation method. These methods may be carried out alone or in combination of two or more kinds thereof.

Furthermore, when reversible addition fragmentation chain transfer polymerization (RAFT) is used as described above for the crosslinking/adsorbing portion 34 with such a configuration, a fragmentation of the chain transfer agent used exists on one end of the dispersion portion 33. Thus, the process [1-1] is completed, a solution containing the obtained dispersion portion 33, the monomers M2, and the monomers M3 is prepared, and living polymerization is carried out again in this solution, thereby forming a crosslinking/adsorbing portion 34. As such, the crosslinking/adsorbing portion 34 is formed by the copolymerization of the second monomers M2 and the third monomers M3 in the presence of both of the second monomers M2 and the third monomers M3 to obtain a random copolymer.

Moreover, as a solvent used in the present process, the same solvent mentioned as in the process [1-1] may be used, and further, the condition for polymerization of the monomers M2 and M3 in the solution can be the same as that for polymerization of the monomers M1 in the solution in the process [1-1].

Furthermore, in the case where a polymer formed by the polymerization of fourth monomers M2′ having a crosslinking group provided with electrostatic adsorbability is used as the crosslinking/adsorbing portion 34, the monomers M2′ are used instead of the monomers M2 in the process [1-2], and further, the process [1-3] is omitted. Thus, a plurality of block copolymers 35 having the dispersion portion 33 and the crosslinking/adsorbing portion 34 linked to each other can be produced. Further, in the case where a polymer formed by the polymerization of fifth monomers M4 provided with a particle adsorbing group and a crosslinking group is used as the crosslinking/adsorbing portion 34, the monomers M4 are used instead of the monomers M2 in the process [1-2], and further, the process [1-3] is omitted. Thus, a plurality of block copolymers 35 having the dispersion portion 33 and the crosslinking/adsorbing portion 34 linked to each other can be produced.

[2] Next, the adsorbing portion 31 is adsorbed onto the surface of the mother particle 2 by the electrostatic adsorbability onto the surface of the mother particle 2 of the adsorption side chain included in the adsorbing unit (process of adsorbing the crosslinking/adsorbing portions included in the plurality of block copolymers onto the surface of the particles).

The adsorption of the adsorbing portion 31 onto the surface of the mother particle 2 can be carried out by mixing the polymer 35 obtained in the process [1] and the mother particle 2 in an appropriate solvent to prepare a solution, and if necessary, followed by stirring, heating, and the like.

Furthermore, as a solvent used in the present process, the same solvents as mentioned in the process [1-1] may be used.

Moreover, examples of the stirring of the solution include stirring dispersion by ultrasonic irradiation, and stirring using a ball mill, a bead mill, or the like.

In addition, the solution is preferably heated under the conditions of a temperature of 100° C. to 200° C. and a time of 1 hour or longer.

Furthermore, the amount of the solution to be prepared in the present process is preferably from about 1% by volume to about 20% by volume, and more preferably from 5% by volume to 10% by volume, with respect to the volume of the mother particle 2. Thus, the opportunity of the contact of the polymer 35 with the mother particle 2 can be increased, and accordingly, the adsorbing portion 31 can be more assuredly adsorbed onto the surface of the mother particle 2.

[3] Next, the crosslinking group included in the crosslinking unit is crosslinked through the crosslinking agent A and the different polymers 35 are linked to each other to fix a plurality of polymers 35 around the mother particles 2 (process of crosslinking the crosslinking groups by a crosslinking agent to link the plurality of block copolymers, thereby forming the coating layer).

As a result, an electrophoretic particle 1 in which at least a part of the mother particle 2 is covered with a coating layer 3 is obtained.

The reaction of the crosslinking groups included in the crosslinking portions 32 provided in the different polymers 35 through the crosslinking agent is carried out by, for example, the following manner. First, the crosslinking agent A is added to a solution containing the mother particles 2 having the plurality of polymers 35 obtained in the process [2] adsorbed on the surface thereof in the adsorbing portion 31. Thereafter, if necessary, the solvent having the crosslinking agent A added thereto is subjected to heating; irradiation with light, electron beams, energy rays such as gamma rays; or the like; etc., thereby making it possible to react the crosslinking group with the crosslinking agent.

In particular, by heating the solution, that is, by heating (warming) the solution to a temperature at which the crosslinking group is reacted with the crosslinking agent, the reaction of the crosslinking group with the crosslinking agent can be more promptly and assuredly carried out.

The heating temperature is slightly different, depending on types of the crosslinking groups and the crosslinking agent, but it is not particularly limited and preferably ranges from about 30° C. to about 100° C. In addition, the heating time (reaction time) preferably ranges from about 0.5 hours to about 10 hours if the heating temperature is set within the above range.

Furthermore, a ratio A:B between the number A of the crosslinking groups provided in the crosslinking portion 32 in the polymer 35 included in the solution and the number B of the functional groups provided in the crosslinking agent is preferably from 1:2 to 10:1, and more preferably 1:1 (equal amounts). Since the unreacted crosslinking agent or the partially reacted crosslinking agent is generated in the case where an excessive amount of crosslinking agent is added, there is a concern that the crosslinking agent as an impurity remains in the electrophoretic particle 1. On the other hand, in the case where the amount of the crosslinking agent is insufficient, a large amount of the unreacted crosslinking group remains in the crosslinking portion 32, and thus, there is a concern that sufficiently high crosslinking strength cannot be achieved for the crosslinking portion 32.

In addition, a curing accelerator is preferably included in the solution. Thus, it is possible to achieve more smooth progress of the reaction among the crosslinking groups through the crosslinking agent.

The curing accelerator is not particularly limited, but examples thereof include imidazoles and derivatives thereof, tertiary amines, and quaternary ammonium compounds. These may be used alone or in combination of two or more kinds thereof.

Furthermore, there is a case where unreacted crosslinking groups remain in the polymer 35. In this case, there is a concern that the crosslinking groups unexpectedly react (decomposition reaction, for example) in the electrophoretic dispersion since the crosslinking group (in particular, an epoxy group) has high reactivity, and as a result, the characteristics such as the dispersion characteristics and the electrification characteristics of the electrophoretic particle 1 vary. For the purpose of preventing such variations in the characteristics, decomposition and washing treatments of the crosslinking groups may be carried out in advance after the completion of this reaction.

Examples of the decomposition treatment include a method in which the electrophoretic particles 1 are brought into contact with a reagent such as general acids, alkali, and sodium sulfite.

In addition, after this reaction, by removing the excess polymer 35 by washing, the electrophoretic particles 1 are purified. Further, there is a case where depending on the kind of the monomer constituting the polymer 35, in particular, the kind of the monomer M1, when the electrophoretic particles 1 are dried, they are not dispersed in the dispersion solvent. In such as case, it is preferable to carry out a solvent replacement method, in which a reaction solvent is gradually replaced with a dispersion solvent (while not carrying out a drying process), during the washing operation.

Through the processes above, the electrophoretic particles 1 are obtained, and therefore, although the mother particle 2 is a particle having no functional group on the surface thereof, irrespective of the kind of the mother particle 2, the polymer 35 can be assuredly fixed on the surface.

### Electrophoretic Dispersion

Next, the electrophoretic dispersion of the invention will be described.

In the electrophoretic dispersion, at least one kind of electrophoretic particles (the electrophoretic particles of the invention) are dispersed (suspended) in a dispersion medium (liquid phase dispersion medium).

As the dispersion medium, a solvent which has a high boiling point of 100° C. or higher and has a relatively high insulation property is preferably used. Examples of the dispersion medium include various kinds of water (for example, distilled water and pure water), alcohols such as butanol and glycerol, cellosolves such as butyl cellosolve, esters such as butyl acetate, ketones such as dibutyl ketone, aliphatic hydrocarbons (liquid paraffin) such as pentane, alicyclic hydrocarbons such as cyclohexane, aromatic hydrocarbons such as xylene, halogenated hydrocarbons such as methylene chloride, aromatic heterocycles such as pyridine, nitriles such as acetonitrile, amides such as N,N-dimethyl formamide, carboxylates, silicone oils, and other various oils. These can be used as a single solvent or a mixed solvent.

Among these, as the dispersion medium, aliphatic hydrocarbons (liquid paraffin such as Isoper and the like) or a solvent having a silicone oil as a main component is preferred. The dispersion medium having liquid paraffin or a silicone oil as a main component has a high effect of inhibiting the aggregation of the electrophoretic particles 1, and therefore, the display performance exhibited by the electrophoretic display device 920 is inhibited from being deteriorated over time. Further, since the liquid paraffin or silicone oil has no unsaturated bond, there are advantages of excellent weather resistance and higher stability.

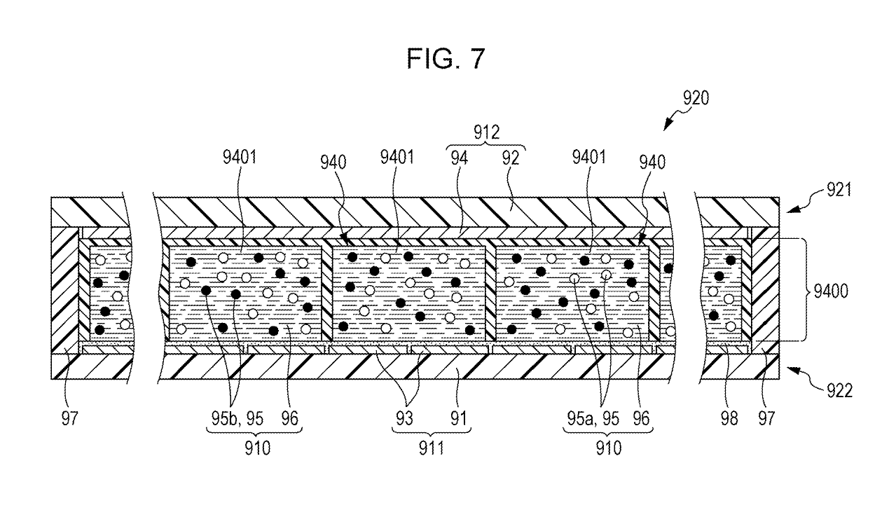

Furthermore, as the dispersion medium, a dispersion medium having a specific dielectric constant of from 1.5 to 3 is preferably used, and a dispersion medium having a specific dielectric constant of from 1.7 to 2.8 is more preferably used. Such a dispersion medium provides excellent dispersibility of the electrophoretic particles 1 as well as a good electrically insulating property, which contributes to realization of an electrophoretic display device 920 shown in FIG. 7, having reduced electricity consumption and capable of high-contrast display. Further, the value of this dielectric constant is a value measured at 50 Hz, which is measured with respect to a dispersion medium having a moisture content of 50 ppm or less and a temperature of 25° C.

Moreover, various additives, for example, a charge controlling agent made of particles, such as electrolytes, (anionic or cationic) surfactants, metal soaps, resins, rubber materials, oils, varnish, and compounds; lubricants; stabilizers; and various dyes may be added to the dispersion medium, if necessary.

In addition, the dispersion of the electrophoretic particles in the dispersion medium can be carried out by one kind or in combination of two or more kinds from a paint shaker method, a ball mill method, a medium mill method, an ultrasonic dispersion method, a stirring dispersion method, and the like, for example.

The electrophoretic particle 1 exhibits excellent dispersibility in such the electrophoretic dispersion due to the operation of the polymer 35 included in the coating layer 3.

### Electrophoretic Display Apparatus

Next, an electrophoretic display device to which an electrophoretic sheet of the invention (an electrophoretic apparatus of the invention) is applied will be described.

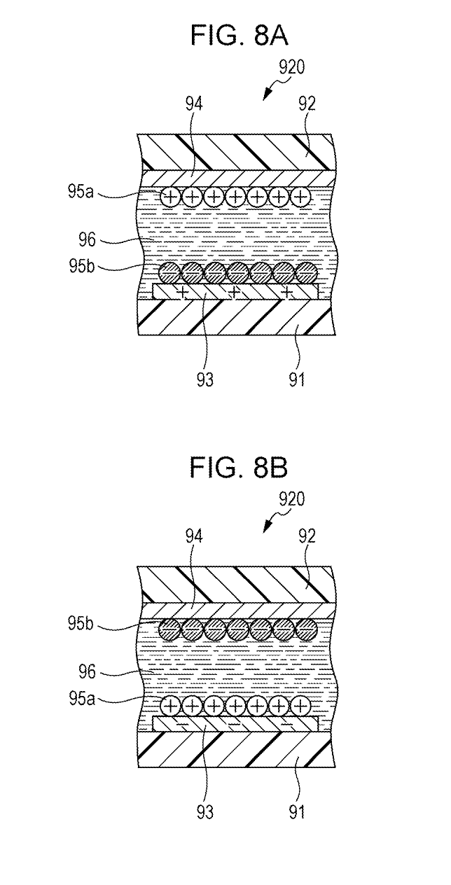

FIG. 7 is a diagram schematically showing a vertical cross-sectional view of an embodiment of the electrophoretic display device, and FIGS. 8A and 8B are diagrams schematically showing an operation principle of the electrophoretic display device shown in FIG. 7. Incidentally, the upper side and the lower side in FIGS. 7 and 8 will be referred to as an “upper side” and a “lower side”, respectively, for the purpose of convenience for explanation.

An electrophoretic display device 920 shown in FIG. 7 has an electrophoretic display sheet (front plane) 921, a circuit substrate (back plane) 922, an adhesive layer 98 which bonds the electrophoretic display sheet 921 and the circuit substrate 922, and a sealing portion 97 which seals a gap between the electrophoretic display sheet 921 and the circuit substrate 922 in an air-tight manner.

The electrophoretic display sheet (the electrophoretic sheet of the invention) 921 includes a substrate 912 which includes a plate-shaped base portion 92 and a second electrode 94 provided on the lower surface of the base portion 92, and a display layer 9400 which is provided on a side of the lower surface (one surface) of the substrate 912 and includes a dividing wall 940 formed into a matrix shape and an electrophoretic dispersion 910.

On the other hand, the circuit substrate 922 includes a facing substrate 911 which includes a plate-shaped base portion 91 and a plurality of first electrodes 93 provided on the upper surface of the base portion 91, and a circuit (not shown) which is provided on the facing substrate 911 (base portion 91) and includes a switching element such as a TFT.

Hereinafter, the configurations of the respective parts will be sequentially described.

The base portions 91 and 92 are respectively configured by sheet-shaped (plate-shaped) members and have a function of supporting and protecting the respective members disposed therebetween.

Although each of the base portions 91 and 92 may be constituted with a member having plasticity or a member having rigidity, it is preferable that each of the base portions 91 and 92 be constituted with a member having plasticity. By using the base portions 91 and 92 having plasticity, it is possible to obtain an electrophoretic display device 920 having plasticity, that is, an electrophoretic display device 920 which is useful for constructing an electronic paper, for example.

Furthermore, when each of the base portions (base layers) 91 and 92 is constituted with a member having plasticity, it is preferable to respectively configure the base portions 91 and 92 by a resin material.

An average thickness of such base portions 91 and 92 is appropriately set depending on the construction material, use purpose, and the like, and is not particularly limited. However, the average thickness preferably ranges from about 20 μm to about 500 μm, and more preferably ranges from about 25 μm to about 250 μm.

On the surfaces of the base portions 91 and 92 on the side of the dividing wall 940, that is, on the upper surface of the base portion 91 and the lower surface of the base portion 92, layer-shaped (film-shaped) first electrodes 93 and second electrode 94 are provided, respectively.

If voltage is applied between the first electrodes 93 and the second electrode 94, an electric field is generated therebetween, and the electric field acts on electrophoretic particles (the electrophoretic particles of the invention) 95.

In the present embodiment, the second electrode 94 is used as a common electrode, and the first electrodes 93 are individual electrodes (pixel electrodes connected to a switching element) which has been divided into a matrix shape (line-column shape). In an electrophoretic display device 920 with such a configuration, a part at which the second electrode 94 and one of the first electrodes 93 are overlapped configures one pixel.

The constructing materials of the respective electrodes 93 and 94 are not particularly limited as long as the construction materials substantially have conductivity.

An average thickness of such electrodes 93 and 94 is appropriately set depending on the construction materials, the use purpose, and the like, and is not particularly limited. However, the average thickness preferably ranges from about 0.05 μm to about 10 μm, and more preferably ranges from about 0.05 μm to about 5 μm.

In addition, the base portion and the electrode which are arranged on the side of the display surface among the base portions 91 and 92 and the electrodes 93 and 94 (the base portion 92 and the second electrode 94 in the present embodiment) respectively have light permeability, that is, the base portion 92 and the second electrode 94 are substantially transparent (colorless and transparent, colored and transparent, or translucent).

The display layer 9400 is provided so as to be in contact with the lower surface of the second electrode 94 on the electrophoretic display sheet 921.

The display layer 9400 is configured such that the electrophoretic dispersion (the aforementioned electrophoretic dispersion of the invention) 910 is accommodated (sealed) within a plurality of pixel spaces 9401 sectioned by the dividing wall 940.

The dividing wall 940 is formed so as to divide the gap between the facing substrate 911 and the substrate 912 in a matrix shape.

Examples of the construction material of the dividing wall 940 include various resin materials which include thermoplastic resins such as an acryl-based resin, a urethane-based resin, and an olefin-based resin, and thermosetting resins such as an epoxy-based resin, a melamine-based resin, and a phenol-based resin, and these may be used alone or in combination of two or more kinds thereof.

The electrophoretic dispersion 910 accommodated in the pixel spaces 9401 is obtained by dispersing (suspending) two kinds of particles, that is, colored particles 95b and white particles 95a (at least one kind of electrophoretic particle 1) in the dispersion medium 96 in the present embodiment, and the aforementioned electrophoretic dispersion of the invention is applied.

According to such an electrophoretic display device 920, the colored particles 95b and the white particles 95a (electrophoretic particles 1) are electrophoresed toward one of the electrodes based on an electric field generated between the first electrodes 93 and the second electrode 94 if voltage is applied therebetween.

In the present embodiment, positively charged particles are used as the white particles 95a, and negatively charged particles are used as the colored particles (black particles) 95b. That is, the electrophoretic particles 1 with positively charged mother particle 2 are used as the white particles 95a, and the electrophoretic particles 1 with negatively charged mother particle 2 are used as the colored particles 95b.

In the case where such the electrophoretic particles 1 are used, the white particles 95a move to the side of the second electrode 94 and are collected in the second electrode 94 as shown in FIG. 8A if the first electrodes 93 have positive potential. On the other hand, the colored particles 95b move to the side of the first electrode 93 and are collected in the first electrodes 93. Therefore, the color of the white particles 95a, that is, a white color appears when the electrophoretic display device 920 is viewed from the upper side (the side of the display surface).

In contrast, the white particles 95a move to the side of the first electrodes 93 and are collected in the first electrodes 93 as shown in FIG. 8B when the first electrodes 93 have negative potential. On the other hand, the colored particles 95b move to the side of the second electrode 94 and are collected in the second electrode 94. Therefore, the color of the colored particles 95b, that is, a black color appears when the electrophoretic display device 920 is viewed from the upper side (the side of the display surface).

With such a configuration, desired information (image) is displayed on the side of the display surface of the electrophoretic display device 920 in accordance with a color combination of the white particles 95a and the colored particles 95b, the number of particles collected in the electrodes 93 and 94, and the like by appropriately setting the charge amounts of the white particles 95a and the colored particles 95b (electrophoretic particles 1), polarities of the electrodes 93 and 94, a potential difference between the electrodes 93 and 94, and the like.

In addition, it is preferable that the specific gravity of the electrophoretic particles 1 is set to be substantially equal to a specific gravity of the dispersion medium 96. In doing so, the electrophoretic particles 1 can stay at constant positions in the dispersion medium 96 for a long time even after the voltage application between the electrodes 93 and 94 is stopped. That is, the information displayed on the electrophoretic display device 920 is maintained for a long time.

In addition, it is preferable that the average particle size of the electrophoretic particle 1 ranges from about 0.1 μm to about 10 μm, and more preferably ranges from about 0.1 μm to about 7.5 μm. By setting the average particle size of the electrophoretic particle 1 within the above range, it is possible to assuredly prevent the electrophoretic particle 1 from agglutinating or settling in the dispersion medium 96, and as a result, it is possible to preferably prevent display quality of the electrophoretic display device 920 is preferably prevented from deteriorating.

In the present embodiment, the electrophoretic display sheet 921 and the circuit substrate 922 are bonded to each other through the adhesive layer 98. In doing so, it is possible to more assuredly fix the electrophoretic display sheet 921 and the circuit substrate 922.

The average thickness of the adhesive layer 98 is not particularly limited, but it preferably ranges from about 1 μm to about 30 μm, and more preferably ranges from about 5 μm to about 20 μm.

The sealing portion 97 is provided between the base portion 91 and the base portion 92 along edge portions thereof. The sealing portion 97 seals the respective electrodes 93 and 94, the display layer 9400, and the adhesive layer 98 in the air-tight manner. In doing so, it is possible to prevent moisture from entering the electrophoretic display device 920 and to thereby more assuredly prevent the display performance of the electrophoretic display device 920 from deteriorating.

As a construction material of the sealing portion 97, the same materials as the aforementioned materials exemplified as the construction material of the dividing wall 940 can be used.

### Electronic Device

Next, the electronic device of the invention will be described.

The electronic device of the invention is provided with the aforementioned electrophoretic display device 920.

### Electronic Paper

First, an embodiment in the case where the electronic device of the invention is applied to an electronic paper will be described.

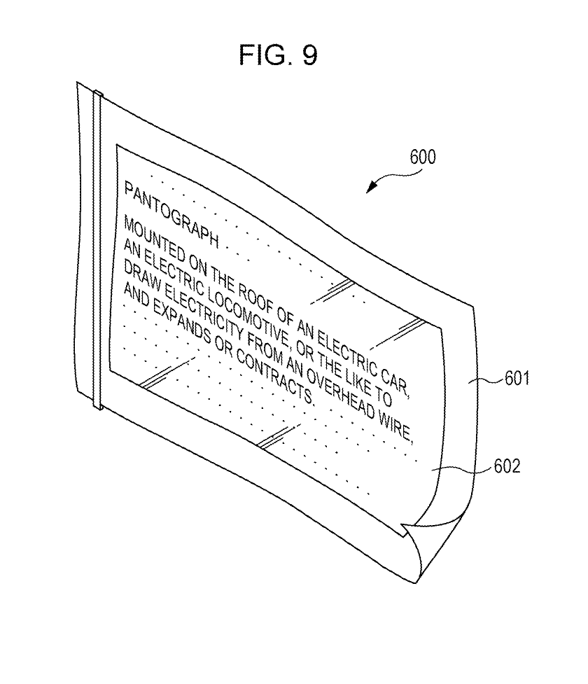

FIG. 9 is a perspective view showing an embodiment of a case where the electronic device of the invention is applied to an electronic paper.

An electronic paper 600 shown in FIG. 9 is provided with a main body 601 which is configured by a rewritable sheet with same texture and flexibility as those of paper, and a display unit 602.

In such an electronic paper 600, the display unit 602 is constituted with the aforementioned electrophoretic display device 920.

### Display

Next, an embodiment in the case where the electronic device of the invention is applied to a display will be described.

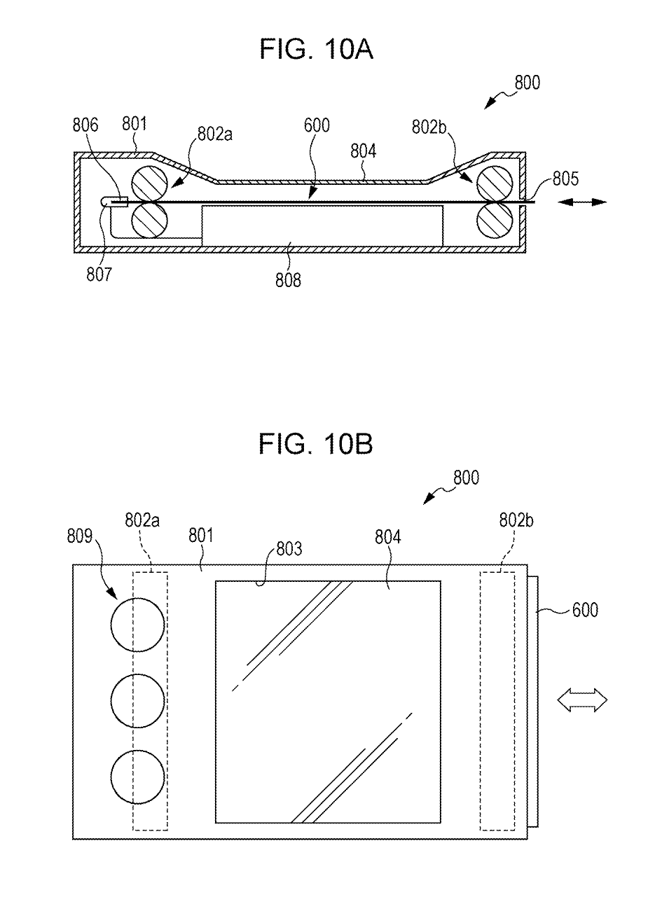

FIGS. 10A and 10B are diagrams showing an embodiment of a case where the electronic device of the invention is applied to a display. In the drawing, FIG. 10A shows a cross-sectional view and FIG. 10B shows a planer view.

A display (display device) 800 shown in FIGS. 10A and 10B includes a main body 801 and an electronic paper 600 which is detachably provided in the main body 801.

An insertion port 805 into which the electronic paper 600 can be inserted is formed on a side part (the right side in FIG. 10A) of the main body 801, and two pairs of transport rollers 802a and 802b are provided inside the main body 801. If the electronic paper 600 is inserted into the main body 801 through the insertion port 805, the electronic paper 600 is arranged in the main body 801 in a state where the electronic paper 600 is pinched between the pairs of transport rollers 802a and 802b.

In addition, a rectangular hole portion 803 is formed on the side of the display surface (the front of the drawing in FIG. 10B) of the main body 801, and a transparent glass plate 804 is embedded in the hole portion 803. In doing so, it is possible to visually recognize the electronic paper 600 in a state where the electronic paper is arranged in the main body 801 from the outside of the main body 801. That is, the display surface of the display 800 is configured by allowing the electronic paper 600 in the state where the electronic paper 600 is arranged in the main body 801 to be visually recognized through the transparent glass plate 804.

In addition, a terminal 806 is provided at a leading end of the electronic paper 600 in the insertion direction (the left side in FIGS. 10A and 10B), and a socket 807 to which the terminal 806 is connected in the state where the electronic paper 600 is arranged in the main body 801 is provided inside the main body 801. A controller 808 and an operation portion 809 are electrically connected to the socket 807.

According to such a display 800, the electronic paper 600 is detachably arranged in the main body 801 and can be carried and used in a state where the electronic paper 600 is removed from the main body 801.

In addition, in such a display 800, the electronic paper 600 is constituted with the aforementioned electrophoretic display device 920.

Furthermore, the electronic device of the invention is not limited to the electronic paper 600 and the display 800 as described above. The electronic device of the invention can be applied to a television, a viewfinder type or monitor-direct-view type video tape recorder, a car navigation apparatus, a pager, a personal digital assistance, an electronic calculator, an electronic newspaper, a word processor, a personal computer, a work station, a video phone, a POS terminal, and a device with a touch panel, for example. It is possible to apply the electrophoretic display device 920 to the display portion of such various kinds of electronic device.

Although the method for preparing an electrophoretic particle, the electrophoretic particle, the electrophoretic dispersion, the electrophoretic sheet, the electrophoretic apparatus, and the electronic device of the invention are described above, based on the embodiments shown in the drawings, the invention is not limited thereto. The configurations of the respective parts can be replaced with arbitrary configurations with the same functions. In addition, other arbitrary constituents may be added to the invention.

Moreover, one process or two or more processes for an arbitrary purpose may be added to the method for preparing an electrophoretic particle of the invention.

### EXAMPLES

Next, specific Examples of the invention will be described.

### 1. Preparation of Electrophoretic Particle and Preparation of Electrophoretic Dispersion

### Example 1

### 1. Synthesis of Dispersion Portion

To a flask were added 10 g (2 mmol) of silicone macromonomers having a molecular weight of 5,000 (“Silaplane FM-0721” manufactured by JNC Corporation), 45 mg (0.2 mmol) of 2-cyano-2-propylbenzodithioate, 33 mg (0.2 mmol) of azobisisobutyronitrile, and ethyl acetate. The mixture in this flask was heated and stirred for 20 hours to polymerize the silicone macromonomers. The resultant was cooled to room temperature to complete the reaction and the solvent was removed to obtain a redish brown silicone polymer reaction solution.

By gel permeation chromatograph with toluene as a developing solvent, the weight average molecular weight (Mw) of the obtained silicone polymer was measured. As a result, it was found that the weight average molecular weight (Mw) of the obtained silicone polymer was 60,000.

### 2. Synthesis of Crosslinking Portion

To a flask were added 1 g (17 μmol) of the silicone polymer obtained above, 97 mg (680 μmol) of glycidyl methacrylate, 2.8 mg (17 μmol) of azobisisobutyronitrile, and ethyl acetate. The mixture in this flask was heated and stirred to carry out polymerization. The resultant was cooled to room temperature to complete the reaction and the solvent was removed to obtain a block copolymer of a dispersible polymer and a crosslinkable polymer.

### 3. Synthesis of Adsorbing Portion

To a flask were added 1 g (17 μmol) of the block copolymer obtained above, 27 mg (255 μmol) of sodium methacrylate, 2.8 mg (17 μmol) of azobisisobutyronitrile, and ethyl acetate. The mixture in this flask was heated and stirred to carry out polymerization. The resultant was cooled to room temperature to complete the reaction and the solvent was removed to obtain a triblock copolymer of a dispersible polymer, a crosslinkable polymer, and an adsorbing polymer.

### 4. Preparation of Electrophoretic Dispersion

To a flask were added 1 g of the block copolymer obtained above, 1 g of a red pigment (anthraquinone: Pigment Red-177), silicone oil (“KF-96-20cs” manufactured by Shin-Etsu Chemical Co., Ltd.), and 1,6-hexanedithiol. The mixture in this flask was heated and stirred, and the block copolymers adsorbed on the particles were crosslinked to obtain electrophoretic particles. The electrophoretic particles were washed using a centrifuge, and then an silicone oil (“KF-96-20cs” manufactured by Shin-Etsu Chemical Co., Ltd.) to prepare an electrophoretic dispersion at a predetermined concentration.

### Example 2

In the same manner as in Example 1 except that the synthesis sequence of the crosslinking portion and the adsorbing portion was reversed, an electrophoretic dispersion of Example 2 was prepared.

### Example 3

In the same manner as in Example 1, synthesis of a dispersion portion was carried out.

Polymerization was carried out using 1 g (17 μmol) of the obtained silicone polymer, 97 mg (680 μmol) of glycidyl methacrylate, 27 mg (255 μmol) of sodium methacrylate, and 2.8 mg (17 μmol) of azobisisobutyronitrile, thereby obtain a block copolymer having crosslinking/adsorbing portions from random copolymerization of crosslinkable polymers and an adsorbing polymers.

In the same manner as in Example 1 except that the obtained block copolymer was used, an electrophoretic dispersion Example 3 was prepared.

### Example 4

In the same manner as in Example 1 except that the amount of 2-cyano-2-propylbenzodithioate used was change to 135 mg (0.6 mmol), synthesis of a dispersion portion was carried out. The weight average molecular weight (Mw) of the obtained silicone polymer was 20,000.

In the same manner as in Example 1 except that 1 g (50 μmol) of the obtained silicone polymer, 285 mg (2000 μmol) of glycidyl methacrylate, and 8.2 mg (50 μmol) of azobisisobutyronitrile were used, synthesis of a crosslinking portion was carried out.

In the same manner as in Example 1 except that 1 g (50 μmol) of the obtained block copolymer, 81 mg (750 μmol) of sodium methacrylate, and 8.2 mg (50 μmol) of azobisisobutyronitrile were used, synthesis of an adsorbing portion was carried out.

In the same manner as in Example 1 except that the obtained block copolymer was used, an electrophoretic dispersion of Example 4 was prepared.

### Example 5

In the same manner as in Example 1 except that the amount of 2-cyano-2-propylbenzodithioate used was changed to 22 mg (0.1 mmol), synthesis of a dispersion portion was carried out. The weight average molecular weight (Mw) of the obtained silicone polymer was 100,000.

In the same manner as in Example 1 except that 1 g (10 μmol) of the obtained silicone polymer, 57 mg (400 μmol) of glycidyl methacrylate, and 1.7 mg (10 μmol) of azobisisobutyronitrile, the synthesis of a crosslinking portion was carried out.

In the same manner as in Example 1 except that 1 g (10 μmol) of the obtained block copolymer, 16 mg (150 μmol) of sodium methacrylate, and 1.7 mg (10 μmol) of azobisisobutyronitrile were used, the synthesis of an adsorbing portion was carried out.

In the same manner as in Example 1 except that the obtained block copolymer was used, an electrophoretic dispersion of Example 5 was prepared.

### Example 6

Omitting the isolation process after the synthesis of the dispersion portion and the isolation process of the crosslinking portion after the synthesis, an electrophoretic dispersion of Example 6 was prepared.

Specifically, the synthesis of the dispersion portion was carried out in the same manner as in Example 1, and then while not removing the solvent from the obtained reaction solution, 970 mg (6800 μmol) of glycidyl methacrylate was added thereto to carry out the synthesis of a crosslinking portion. 270 mg (2550 μmol) of sodium methacrylate was added to the obtained reaction solution to carry out the synthesis of an adsorbing portion.

In the same manner as in Example 1 except that the obtained block copolymer was used, an electrophoretic dispersion of Example 6 was prepared.

### Example 7

In the same manner as in Example 1 except that 10 g (29 mmol) of stearyl methacrylate was used instead of the silicone macromonomers, a dispersion portion was synthesized. The weight average molecular weight (Mw) of the obtained polymer was 50,000.

In the same manner as in Example 1 except that 1 g (20 μmol) of the obtained polymer, 114 mg (800 μmol) of glycidyl methacrylate, and 3.4 mg (20 μmol) of azobisisobutyronitrile were used, the synthesis of a crosslinking portion was carried out.

In the same manner as in Example 1 except that 1 g (20 μmol) of the obtained block copolymer, 32 mg (300 μmol) of sodium methacrylate, and 3.4 mg (20 μmol) of azobisisobutyronitrile were used, the synthesis of an adsorbing portion was carried out.

In the same manner as in Example 1 except that the obtained block copolymer was used and Isopar G (manufactured by Exxon Mobil Corporation) was used instead of silicone oil, an electrophoretic dispersion of Example 7 was prepared.

### Example 8

In the same manner as in Example 1 except that the amount of glycidyl methacrylate used was changed to 12 mg (85 μmol), the synthesis of a block copolymer was carried out.

In the same manner as in Example 1 except that the obtained block copolymer was used, an electrophoretic dispersion of Example 8 was prepared.

### Example 9

In the same manner as in Example 1 except that the amount of glycidyl methacrylate used was changed to 48 mg (340 μmol), the synthesis of a block copolymer was carried out.

In the same manner as in Example 1 except that the obtained block copolymer was used, an electrophoretic dispersion of Example 9 was prepared.

### Example 10

In the same manner as in Example 1 except that the amount of glycidyl methacrylate used was changed to 145 mg (1020 μmol), the synthesis of a block copolymer was carried out.

In the same manner as in Example 1 except that the obtained block copolymer was used, an electrophoretic dispersion of Example 10 was prepared.

### Example 11

In the same manner as in Example 1 except that the amount of glycidyl methacrylate used was changed to 193 mg (1360 μmol), the synthesis of a block copolymer was carried out.

In the same manner as in Example 1 except that the obtained block copolymer was used, an electrophoretic dispersion of Example 11 was prepared.

### Example 12

In the same manner as in Example 1 except that 1,3-diaminopropane was used instead of 1,6-hexanedithiol, an electrophoretic dispersion of Example 12 was prepared.

### Example 13

In the same manner as in Example 1 except that hexamethylene diamine was used instead of 1,6-hexanedithiol, an electrophoretic dispersion of Example 13 was prepared.

### Example 14

In the same manner as in Example 1, the synthesis of a dispersion portion was carried out.

Using 1 g (17 μmol) of the obtained silicone polymer, 154 mg (935 μmol) of 2-aminoethyl methacrylate hydrochloride, and 2.8 mg (17 μmol) of azobisisobutyronitrile, the synthesis of a crosslinking/adsorbing portion with the adsorption side chain further including a crosslinking group was carried out.

In the same manner as in Example 1 except that the obtained block copolymer was used and poly(ethylene glycol) diglycidyl ether was used instead of 1,6-hexanedithiol, an electrophoretic dispersion of Example 14 was prepared.

### Example 15

In the same manner as in Example 1, the synthesis of a dispersion portion was carried out.

Using 1 g (17 μmol) of the obtained silicone polymer, 224 mg (935 μmol) of a compound of the formula (A5), and 2.8 mg (17 μmol) of azobisisobutyronitrile, monomers having adsorptive groups and crosslinking groups were polymerized, and synthesis of a crosslinking/adsorbing portion was carried out.

In the same manner as in Example 1 except that the obtained block copolymer was used, an electrophoretic dispersion of Example 15 was prepared.

### Example 16

In the same manner as in Example 1 except that the amount of sodium methacrylate used was changed to 4 mg (34 μmol), the synthesis of a block copolymer was carried out.

In the same manner as in Example 1 except that the obtained block copolymer was used, an electrophoretic dispersion of Example 16 was prepared.

### Example 17

In the same manner as in Example 1 except that the amount of sodium methacrylate used was changed to 74 mg (680 μmol), the synthesis of a block copolymer was carried out.

In the same manner as in Example 1 except that the obtained block copolymer was used, an electrophoretic dispersion of Example 17 was prepared.

### Example 18

In the same manner as in Example 1 except that 40 mg (255 μmol) of 2-(dimethylamino)ethyl methacrylate was used instead of sodium methacrylate, the synthesis of a block copolymer was carried out.

In the same manner as in Example 1 except that the obtained block copolymer was used and a green pigment (phthalocyanine green: PigmentGreen-7) was used instead of the red pigment, an electrophoretic dispersion of Example 18 was prepared.

### Example 19

In the same manner as in Example 1 except that 44 mg (255 μmol) of benzyl methacrylate was used instead of sodium methacrylate, the synthesis of a block copolymer was carried out.

In the same manner as in Example 1 except that the obtained block copolymer was used and carbon black was used instead of the red pigment, an electrophoretic dispersion of Example 19 was prepared.

### Comparative Example 1

In the same manner as in Example 1 except that 1 g (0.2 mmol) of silicone macromonomers having a molecular weight of 5,000 (“Silaplane FM-0721” manufactured by JNC Corporation), 97 mg (680 μmol) of glycidyl methacrylate, 27 mg (255 μmol) of sodium methacrylate, and 33 mg (0.2 mmol) of azobisisobutyronitrile were used to carry out polymerization and the obtained random copolymer was used, an electrophoretic dispersion was prepared.

### Comparative Example 2

In the same manner as in Example 1 except that the synthesis of the crosslinking portion was omitted, an electrophoretic dispersion of Comparative Example 2 was prepared.

### Comparative Example 3

In the same manner as in Example 1 except that the synthesis of the adsorbing portion was omitted, an electrophoretic dispersion of Comparative Example 3 was prepared.

### 2. Evaluation of Electrophoretic Dispersion

### 2.1 Volume Average Particle Diameter of Dispersed

### Electrophoretic Particles

For the electrophoretic dispersions obtained in the respective Examples and Comparative Examples, the volume average particle diameter of the electrophoretic particles included in the electrophoretic dispersion was measured, using a static light scattering method.

### 2.2 Long-Term Stability of Dispersed Electrophoretic Particles

After measuring the volume average particle diameter of the dispersed electrophoretic particles in 2.1, the electrophoretic dispersion was left to stand under the condition of 60° C. for one week, and thereafter, the volume average particle diameter of the electrophoretic particles included in the electrophoretic dispersion was measured under the same condition as in 2.1.

In addition, based on the volume average particle diameter before and after leaving the electrophoretic dispersion to stand, the evaluations on the basis of the following criteria were conducted.

### Evaluation of Long-Term Stability

A: The change amount in the particle diameter with relative to the volume average particle diameter measured in 2.1 is less than 5%

B: The change amount in the particle diameter with relative to the volume average particle diameter measured in 2.1 is from 5% to less than 20%

C: The change amount in the particle diameter with relative to the volume average particle diameter measured in 2.1 is from 20% to less than 50%

D: Completely settled

The results of the respective evaluations in 2.1 to 2.2 above are shown in Table 1. Further, the number of the crosslinking units included in the crosslinking portion and the number of the adsorbing units included in the adsorbing portion were identified by a 1H-NMR method. Further, since the adsorption side chain further includes a crosslinking group in Example 14, simply, the number of the crosslinking units per crosslinking portion is 40 and the number of the adsorbing units per adsorbing portion is 15.

TABLE 1

| | | | Number of | | | | Evaluation | |
|---|---|---|---|---|---|---|---|---|
| | | | crosslinking | | | | Volume | |
| | Molecular | | units per | Crosslinking group | | Kind of mother | average | |
| | weight of | First monomers | crosslinking | in the crosslinking | Number of adsorbing | particle/ | particle | Long- |
| | dispersion | M1 in dispersion | portion: | portion/crosslinking | units per adsorbing | adsorbing | diameter | term |
| | portion | portion/solvent | monomers | agent | portion: monomers | group | [nm] | stability |
| Example 1 | 60,000 | Silicone | 40 | Epoxy group/ | 15 | Anthraquinone | 87 | A |
| Example 2 | | monomers/ | | 1,6-hexanediol | | (PR177)/ | 110 | C |
| Example 3 | | silicone oil | | | | carboxyl | 89 | B |
| Example 4 | 20,000 | | | | | group | 147 | C |
| Example 5 | 100,000 | | | | | | 119 | B |
| Example 6 | 60,000 | | | | | | 120 | C |
| Example 7 | | Alkyl | | | | | 82 | A |
| | | monomers/Isopar | | | | | | |
| Example 8 | | Silicone | 5 | | | | 110 | D |
| Example 9 | | monomers/ | 20 | | | | 95 | B |
| Example 10 | | silicone oil | 60 | | | | 175 | B |
| Example 11 | | | 80 | | | | 283 | D |
| Example 12 | | | 40 | Epoxy group/ | | | 111 | C |
| | | | | 1,3-diaminepropane | | | | |
| Example 13 | | | | Epoxy group/ | | | 107 | B |
| | | | | hexamethylenediamine | | | | |
| Example 14 | | | | Amino group/ | | | 103 | B |
| | | | | poly(ethylene | | | | |
| | | | | glycol)diglycidyl | | | | |
| | | | | ether (molecular | | | | |
| | | | | weight 500) | | | | |
| Example 15 | | | | Carboxyl group/ | | | 105 | B |
| | | | | 1,6-hexanediol | | | | |
| Example 16 | | | | Epoxy group/ | 2 | | 120 | C |
| Example 17 | | | | 1,6-hexandiol | 40 | | 153 | D |
| Example 18 | | | | | 15 | Phthalocyanine | 77 | A |
| | | | | | | green (PG7)/ | | |
| | | | | | | amino group | | |
| Example 19 | | | | | | Carbon black/ | 149 | A |
| | | | | | | aromatic group | | |
| Comparative | — | Silicone | 40 | Epoxy group/ | 15 | Anthraquinone | 421 | D |
| Example 1 | | monomers/ | | 1,6-hexanediol | | (PR177)/ | | |
| Comparative | 60,000 | silicone oil | 0 | | | carboxyl group | 386 | D |
| Example 2 | | | | | | | | |
| Comparative | | | 40 | | 0 | | 452 | D |
| Example 3 | | | | | | | | |

As clearly seen from Table 1, for all the electrophoretic dispersions obtained in the respective Comparative Examples, the electrophoretic particles could not be dispersed in the electrophoretic dispersion for a long period of time. In contrast, it was found that the volume average particle diameter of the electrophoretic dispersions obtained in the respective Examples was smaller than those of the respective Comparative Examples. Further, the electrophoretic dispersions obtained in the respective Examples, the dispersibility of the electrophoretic particles in the electrophoretic dispersion was excellent and this dispersibility could be maintained over a long period of time.

The entire disclosure of Japanese Patent Application No. 2014-066355, filed Mar. 27, 2014, No. 2014-066356, filed Mar. 27, 2014 and No. 2014-066357, filed Mar. 27, 2014 are expressly incorporated by reference herein.

What is claimed is:

1. A method for preparing an electrophoretic particle including a particle and a coating layer covering at least a part of the particle, comprising:
obtaining the plurality of block copolymers having dispersion portions and crosslinking/adsorbing portions having crosslinking groups and being linked to the dispersion portions;
adsorbing the crosslinking/adsorbing portions included in the plurality of block copolymers onto the surface of the particles; and
crosslinking the crosslinking groups by a crosslinking agent to link the plurality of block copolymers, thereby forming the coating layer,
wherein the dispersion portions are formed by the living polymerization of first monomers having functional groups contributing the dispersibility of the particles into a dispersion medium, and
the crosslinking/adsorbing portions are formed by the living polymerization of at least one kind of monomers, and thus provided with adsorbability onto the surface of the particles.

2. The method for preparing an electrophoretic particle according to claim 1, wherein the at least one kind of monomers includes second monomers having the crosslinking groups and third monomers having the particle adsorbing groups provided with adsorbability, and
in the process of obtaining the plurality of block copolymers, the crosslinking/adsorbing portions are formed by the copolymerization of the second monomers and the third monomers.

3. The method for preparing an electrophoretic particle according to claim 2, wherein the process of obtaining the plurality of block copolymers includes forming a crosslinking portion by the polymerization of the second monomers and forming an adsorbing portion by the polymerization of the third monomers, and
the crosslinking/adsorbing portions are formed by obtaining block copolymers having the crosslinking portions and the adsorbing portions linked to each other.

4. The method for preparing an electrophoretic particle according to claim 2, wherein in the process of obtaining the plurality of block copolymers, the crosslinking/adsorbing portions are formed by obtaining random copolymers by the copolymerization of the second monomers and the third monomers in the presence of both of the second monomers and the third monomers.

5. The method for preparing an electrophoretic particle according to claim 2, wherein the particle adsorbing group is at least one selected from an anionic group, a cationic group, and a nonionic group.

6. The method for preparing an electrophoretic particle according to claim 1, wherein the at least one kind of monomers includes fourth monomers having the crosslinking groups provided with adsorbability, and
in the process of obtaining the plurality of block copolymers, the crosslinking/adsorbing portions are formed by the polymerization of the fourth monomers.

7. The method for preparing an electrophoretic particle according to claim 1, wherein the at least one kind of monomers include fifth monomers having the crosslinking groups and the particle adsorbing group provided with adsorbability, and
in the process of obtaining the plurality of block copolymers, the crosslinking/adsorbing portions are formed by the polymerization of the fifth monomers.

8. The method for preparing an electrophoretic particle according to claim 7, wherein the fifth monomers includes two or more kinds of monomers, and
in the process of obtaining the plurality of block copolymers, the crosslinking/adsorbing portions are formed by the polymerization of the two or more kinds of monomers.

9. The method for preparing an electrophoretic particle according to claim 1, wherein the living polymerization is reversible addition fragmentation chain transfer polymerization.

10. The method for preparing an electrophoretic particle according to claim 1, wherein the plurality of block copolymers are isolated and purified before the process of adsorbing the crosslinking/adsorbing portions.

11. The method for preparing an electrophoretic particle according to claim 1, wherein the adsorbability is electrostatic adsorbability onto the surface of the particle.

12. An electrophoretic particle having a particle and a coating layer covering at least a part of the particle, wherein the coating layer includes a plurality of block copolymers having dispersion portions and crosslinking/adsorbing portions having crosslinking groups and being linked to the dispersion portions,
the crosslinking/adsorbing portions are adsorbed onto the surface of the particles and the plurality of block copolymers are linked by a crosslinking agent in the crosslinking groups,
the dispersion portions are formed by the polymerization of first monomers having functional groups contributing the dispersibility of the particles into a dispersion medium, and
the crosslinking/adsorbing portions are formed by the polymerization of at least one kind of monomers, and thus provided with adsorbability onto the surface of the particles.

13. The electrophoretic particle according to claim 12, wherein the at least one kind of monomers includes second monomers having the crosslinking groups and third monomers having the particle adsorbing groups provided with adsorbability, and
the crosslinking/adsorbing portions are formed by the copolymerization of the second monomers and the third monomers.

14. The electrophoretic particle according to claim 13, wherein the crosslinking/adsorbing portions are block copolymers including crosslinking portions formed by the polymerization of the second monomers and adsorbing portions formed by the polymerization of the third monomers.

15. The electrophoretic particle according to claim 14, wherein the adsorbing portion has 5 to 30 repeating units of the third monomers.

16. The electrophoretic particle according to claim 9, wherein the crosslinking portion has 10 to 70 repeating units of the second monomers.

17. An electrophoretic dispersion comprising electrophoretic particles prepared by the method for preparing an electrophoretic particle according to claim 1 or the electrophoretic particle according to claim 12.

18. An electrophoretic sheet comprising:
a substrate, and
a plurality of structures disposed on the top of the substrate,
wherein the plurality of structures accommodates the electrophoretic dispersion according to claim 17.

19. An electrophoretic apparatus provided with the electrophoretic sheet according to claim 18.

20. An electronic device provided with the electrophoretic apparatus according to claim 19.
